(19) United States
(12) Patent Application Publication
(10) Pub. No.: US 2026/0291146 A1
(43) Pub. Date: Sep. 24, 2026

(54) CONNECTORS WITH GROUND CAGE RECEPTACLE FOR DATACENTER

(71) Applicant: Nvidia Corporation, Santa Clara, CA (US)

(72) Inventors: Karl Joseph Bois, Fort Collins, CO (US); Michael David Herring, Apex, NC (US); Joseph Michael Gallo, Littleton, MA (US); Kevin Darrel Conn, Montgomery, TX (US); Cong Gao, Pflugerville, TX (US); Arturo Pachon Munoz, San Jose, CA (US); Gabriele Gorla, Santa Clara, CA (US); Ryan Albright, Beaverton, OR (US); Trevor Mitchell, Santa Clara, CA (US)

(21) Appl. No.: 19/378,870

(22) Filed: Nov. 4, 2025

Related U.S. Application Data
(60) Provisional application No. 63/774,580, filed on Mar. 19, 2025.
(60) Provisional application No. 63/791,249, filed on Apr. 18, 2025.

(51) Int. Cl. H01R 13/6594; H01R 12/71

(52) U.S. Cl. CPC H01R 13/6594; H01R 12/716

(57) ABSTRACT

Systems and methods disclosed herein are for a connector having a ground cage receptacle which may be around at least a barrel section of the connector. The barrel section may include a pin and a spring to transmit a data signal. The ground cage receptacle may couple to a receiving cage receptacle of a circuit board to provide a ground reference for the data signal. The pin may extend from or retract into the barrel section based in part at least one stop feature associated with a receiving cage receptacle. The stop feature may hold the ground cage receptacle at a predetermined position with respect to the receiving cage receptacle. The stop feature may allow the pin to contact a signal surface contact pad on the circuit board for transmission of the data signal to the circuit board.

### CROSS-REFERENCE TO RELATED APPLICATION(S)

This is a non-provisional application that is related to and that claims the benefit of priority from U.S. provisional patent application Ser. No. 63/791,249, filed Apr. 18, 2025, and entitled “LEAD FRAME CONNECTORS FOR DATACENTER,” and U.S. provisional patent application Ser. No. 63/774,580, filed Mar. 19, 2025, and entitled “SPRING-LOADED LEAD FRAME CONNECTORS,” the entire contents of both of which are incorporated by reference herein and form a part of this specification for all intents and purposes.

### TECHNICAL FIELD

At least one aspect herein pertains generally to circuit board connectors and specifically pertains to features for use within circuit board connectors.

### BACKGROUND

A circuit board connector, such as a lead frame connector, may be a bridge for signals, power, or other connections that may be used between circuit boards, such as between daughter boards or cards and backplanes or midplanes of a rack in a datacenter.

### BRIEF DESCRIPTION OF THE DRAWINGS

Various embodiments in accordance with the present disclosure will be described with reference to the drawings, in which:

FIG. 1A illustrates details of a circuit board connector having a ground cage receptacle which is separated, by one or more dielectric structures, from barrel sections and pins of a pair of leads therein, in one example;

FIG. 1B illustrates another example of dielectric structures usable in a circuit board connector, relative to FIG. 1A, and having a different dimension or shape which is predetermined based at least in part on an intended impedance profile;

FIG. 1C illustrates another example of dielectric structures usable in a circuit board connector and having a different dimension or shape which is predetermined based at least in part on an intended impedance profile;

FIG. 1D illustrates yet another example of dielectric structures usable in a circuit board connector and having a different dimension or shape which is predetermined based at least in part on an intended impedance profile;

FIG. 1E illustrates a further example of dielectric structures usable in a circuit board connector and having a different dimension or shape which is predetermined based at least in part on an intended impedance profile;

FIG. 1F illustrates an intended impedance profile from the dielectric structures in the circuit board connector of FIG. 1A, in one example;

FIG. 1G illustrates another example of an intended impedance profile from the dielectric structures in the circuit board connector of FIG. 1B;

FIG. 1H illustrates another example of an intended impedance profile from the dielectric structures in the circuit board connector of FIG. 1C;

FIG. 1AA illustrates regular and cross-section views of a ground cage receptacle for a lead frame connector which is to be coupled to a receiving cage receptacle, in accordance with at least some embodiments;

FIG. 1BB illustrates regular and cross-section views of a ground cage receptacle for a lead frame connector, with internal coupling, to a receiving cage receptacle, in accordance with at least some embodiments;

FIG. 1CC illustrates regular and cross-section views of a ground cage receptacle for lead frame connectors, with external coupling, to a receiving cage receptacle, in accordance with at least some embodiments;

FIG. 1DD illustrates different lead frame connectors having a lead section and a barrel section, in accordance with at least some embodiments;

FIG. 1EE illustrates cross-section views of a lead frame connector having a lead section and a barrel section, in accordance with at least some embodiments;

FIG. 1FF illustrates process details of a barrel section having a pin and a spring, in accordance with at least some embodiments;

FIG. 1GG is a perspective view of an angled feature to allow a 90-degree angle of separation between the barrel sections of a connector that is part of a lead frame connector, in accordance with at least some embodiments;

FIG. 1HH is a side view of an angled feature to allow a 90-degree angle of separation between the barrel sections of a connector that is part of a lead frame connector, in accordance with at least some embodiments;

FIG. 1II is an excerpt view of a connector having retracted pins in its barrel sections, in accordance with at least some embodiments.

FIG. 1JJ illustrates a cross-sectional excerpt view of a connector having retracted pins and compressed springs in its barrel sections, in accordance with at least some embodiments;

FIG. 2A illustrates a connection between two circuit boards and is used for differential signaling by a lead frame connector, in accordance with at least some embodiments.

FIG. 2B illustrates a connector between a daughter board and a backplane or a midplane, in accordance with at least some embodiments;

FIG. 3A illustrates a process or method for a circuit board connector having a ground cage receptacle which is separated, by one or more dielectric structures, from barrel sections and pins of a pair of leads therein, in accordance with at least some embodiments;

FIG. 3AA illustrates a process or method for a connector having a lead section and a barrel section, in accordance with at least some embodiments;

FIG. 3BB illustrates a process or method for a connector having ground cage receptacles, in accordance with at least some embodiments;

FIG. 4 illustrates an example datacenter to apply at least one embodiment for power connection in FIGS. 1A-3BB and 5-7;

FIG. 5 illustrates aspects of an example rack to apply at least one embodiment in FIGS. 1A-4 and 6A-7;

FIG. 6A illustrates an example datacenter system, according to at least some embodiments;

FIG. 6B is a block diagram that schematically illustrates a computing system that may be a datacenter or a High-Performance Computing (HPC) cluster, in which at least one embodiment described herein may be used;

FIG. 6C illustrates a computer system, according to at least one example, in which at least one embodiment described herein may be used; and

FIG. 7 illustrates an example network configuration of components that can be used to implement aspects of various embodiments, such as to provide, generate, modify, encode, process, fuse, and/or transmit generated image data, calculated measurements, or other such content.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A lead frame connector may be a bridge connector that may be used between circuit boards (also referred to herein as printed circuit boards (PCBs)). The PCBs may be daughter boards (or cards) and backplanes or midplanes of a rack in a datacenter. In one example, each lead frame connector may include multiple connectors forming one or more circuit board connectors within a lead frame connector, for example. Pairs of the multiple connectors may be used for differential signaling and may represent one circuit board connector, in some examples. Each of the multiple connectors may be coupled to corresponding receiving connectors through the circuit board connector. The circuit board connector may include a ground cage receptacle that is around a lead section and a barrel section of a lead. When more than one lead is available, such as a pair of leads for the differential signaling, the ground cage receptacle may be around the pair of leads. The barrel section may be formed or associated with the lead section, and may have a pin and a spring therein. The ground cage receptacle is to couple with a receiving cage receptacle of a receiving connector. The receiving cage receptacle includes one or more stop features to hold the ground cage receptacle and the barrel section at predetermined positions so that the pins, supported by the springs, of each of the multiple connectors, may assert a predetermined connection pressure or have a predetermined connection resistance to signal the surface contact pad of the backplane or midplane. As used herein, a surface contact pad may be a conductive area on the PCB or may be a lead from a component of the PCB designed to electrically connect to other components internally or externally, with respect to the PCB.

There may be a pair of leads, representing at least two connectors per pair, providing differential signaling with the ground cage receptacle providing a ground reference, as part of a circuit board connector. For example, a circuit board connector may include a ground cage receptacle which is around a pair of leads that may include the barrel sections and the lead sections having the pins. The barrel sections may be of different dimensions relative to the pins at least because the pins are thinner and are able to slide within the barrel sections upon contact with a receiving connector of a circuit board. The ground cage receptacle may be separated from the barrel sections and the pins by one or more dielectric structures. The one or more dielectric structures may include one or more of a dimension or shape which is predetermined based at least in part on an intended impedance profile to be maintained across the barrel sections and the pins. In some examples, the intended impedance profile may include intended impedance values in the range of about 82 to about 100 Ohms of differential impedance. In some examples, the intended impedance profile may include intended impedance values in the range of about 85 to about 100 Ohms of differential impedance. In some examples, the intended impedance profile may include intended impedance values in the range of about 82 Ohms or 83 Ohms of differential impedance. The dimension or shape of the dielectric structures may be predetermined to allow or support a less than one percent deviation in a practical application of an impedance profile, with respect to the intended impedance profile. The dielectric structures may allow alignment of the pins and may ensure consistent impedance throughout the circuit board connector. The dielectric structures may also provide mechanical rigidity to the pins, and may ensure that they remain parallel and aligned. The rigidity may also support or ensure maintenance of a signal integrity in high-speed applications.

There may be different shapes and sizes of the one or more dielectric structures, including instances of an air gap within the dielectric structures. The impedance profile may be part of different impedance profiles available through the one or more dielectric structures. In differential signaling, the different impedance profiles assist with preventing signal reflections during mismatch of impedances, minimizes loss of signal or signal characteristics, improves immunity to noise, reduces sensitivity with respect to the noise, allows for different frequency, time, or speed of the differential signals, allows for predictable signaling, and allows for improved simulation prior to physical application of the signals.

The ground cage receptacle with the dielectric structures herein may address problems associated with signal and power interconnect (connectors) which may often have lead pairs with different dimensions, such as the barrel section and the pin of a lead section. The barrel sections and pins may need to be held steady and may need to be supported by a ground shield that accommodates the different dimensions. Approaches to encase the lead pair may cause impedance issues, such as an impedance mismatch which may affect at least differential signaling. The encasing of the lead pair may not provide tuning of an electrical performance required to ensure effective impedance within the connectors. An encasing material may allow mechanical support but may produce impedances that are too low for high-speed signaling requirements. In some examples, a deviation in an intended impedance profile would be more than 30%.

The ground cage receptacle with the dielectric structures herein provides a solution to accommodate the different dimensions and to provide an intended impedance profile based in part on a practical application. The practical application may include a differential signaling application with a specific frequency. The one or more dielectric structures may include one or more of a dimension or shape which is predetermined based at least in part on the intended impedance profile to be maintained across the barrel sections and the pins. In some examples, a dielectric structure within a ground cage receptacle may also provide mechanical support and/or electrical tuning to a pair of leads and a ground reference. The dielectric structure addresses issues from filling of the volume between the ground cage receptacle and the barrel sections and pins with a dielectric, which may not provide the necessary mechanical support but would also not yield an acceptable electrical solution or tuning in at least a use case of a differential signaling circuit board connector. The tuning may be with respect to an electrical performance of the effective differential impedance within the circuit board connector thereby addressing both mechanical stability and electrical performance in lead frame connectors, in some examples. In some examples, if filling of the volume with a material works mechanically, there may be additional or unintended impedances which may be too low and may be counter to requirements for a high speed signaling. In some examples, the deviation would be more than 30%, but the use of the present dielectric structure may allow the deviation to be less than 1%.

Separately, when used, the ground cage receptacle and the receiving cage receptacle support or allow a ground reference between the multiple connectors and receiving connectors. The lead section and the barrel section may provide the differential signaling while the ground cage receptacle provides the ground reference for the differential signaling. The ground cage receptacle allows coupling of ground connections from the daughter board to ground surface contact pads, channels, or lines on the backplane or midplane. The ground surface contact pads, channels, or lines may be around the signal surface contact pads so that the pins may make contact internally while the ground cage receptacle may make contact externally, between the lead frame connector and the receiving connectors. At least the use of channels or lines instead of contact pads for the ground reference may promote signal integrity, in one example.

In some examples, a ground reference may be provided through the ground cage receptacle and the receiving cage receptacle in a mating sequence. For example, the ground cage receptacle and the receiving cage receptacle may be able to contact or engage, first, in a mating sequence. In some examples, the pins may contact for the differential signaling, other signaling, or power, following the mating of the ground cage receptacle and the receiving cage receptacle. In some examples, the sequence may be reversed with the ground reference provided after the differential signaling, other signaling, or power, but in some cases, there may be a presence signal using the pins provided as part of the mating sequence. The presence signal may occur before or after the ground reference and/or before or after the differential signaling, other signaling, or power. The presence signal indicates presence of the circuit board connector, in a coupling, against a receiving connector. In some examples, the ground cage receptacle may be used for the presence signal.

In another example, the one or more stop features may be formed externally to the receiving connector or internally to the receiving connector and may be formed by an insulation material between the pins and the receiving cage receptacle or insulating material on the outside of the receiving connector. In one example, the insulating material may have dielectric properties to prevent short circuits between pins and between a pin and the receiving cage receptacle or a ground cage receptacle. In addition, the insulating materials allow maintenance of impedance control within the lead frame connector and the receiving connector. In another example, the one or more stop features may act on one or more of the ground cage receptacle or the barrel section to prevent the ground cage receptacle and the barrel section from extending too far to the backplane or midplane and fully depressing the pin.

The lead frame connector may include an array of connectors. Each of the connectors may include the lead section and the barrel section. The barrel section may be formed from a portion of the lead section. In another example, the barrel section may be prepared separately from the lead section and may be associated with the lead section by a solder. The pin and the spring arrangement in the barrel section may allow the pin to extend from or retract into the barrel section, based in part on an interface with one or more of the spring or the one or more stop features. Each connector having such a pin and a spring may be a single pogo pin feature of the lead frame connector. The pogo pin may be in reference to the pin configured or adapted to extend from or retract into the barrel section, which retains its communication capabilities for power and signals. The pin may be to contact a surface contact pad on a circuit board to pass signals from the circuit board and through the connector. A lead frame connector may include multiple ones of the parallel configuration of connectors in the array of connectors or in another similar format.

The parallel configuration of connectors may include at least two connectors providing differential signals. Each of a pair of two connectors may be within a cage receptacle or other structure to support connection to a pair of surface contact pads. The connector may include a stamped lead frame segment forming the lead section. A width of the end of the connector may be suitable or predetermined to allow the end to be formed into a cylinder or a barrel and referred to herein as a barrel section of the connector. The pin may be inserted through the barrel and interfaced with the spring that is also inserted into the barrel. A portion of the top of the barrel may be folded over an opening of the barrel to prevent the spring from exiting the barrel from the top. The pin may be compressed from the bottom, and the top of the barrel may be rolled inward to also prevent the pin from being ejected once the pin has depressed the spring, simplifying the connection process. This provides the barrel section of the connector. The connector may be used against surface contact pads of a backplane or a midplane, along with other similar connectors.

A further problem addressed by the connectors described herein is that copper-based signal and power interconnect (connectors) often have pin compliant interfaces which anchor into a PCB. The anchoring may be performed by plating through-hole or compression pins that mate to surface pads. In each case, the insertion or compression force of these schemes may be very high. In addition, compression pins may require a fixture to apply a constant force to the connector so that the pins remain in contact with a surface of the PCB having surface contact pads. There may be sockets that may be inserted in between a connector, which provides a spring interface, but these may require an additional interface between the connector and the PCB. There may be issues relating to a need to convert ground reference to pass through ground pins and a need for supplementary hardware to support ground pin connections, which may complicate the design and assembly process, as well as issues related to bent pins caused by misalignment during component mating and to improper separation of ground and signal interfaces for high-speed signal performance and potential interference.

Another problem addressed is that copper-based signal and power interconnect (connectors) may include pins that may be compliant interfaces which anchor into a PCB. The anchoring may be performed by plating through-holes or compression pins that mate to surface contact pads. In each case, the insertion or compression force of these schemes may be high. In addition, compression pins may require a fixture to apply a constant force to the connector so that the pins remain in contact with a surface of the PCB having surface contact pads. There may be sockets that may be inserted in between a connector, which provides a spring interface, but these may require an additional interface between the connector and the PCB.

A further solution herein may use the ground cage receptacle which acts as a natural extension of the connector's internal design without need for physical conversion for ground reference through ground pins. The ground cage receptacle serves as a receptacle for a high-speed signaling connector. The ground cage receptacle may not include any signal pins and may interface between a ground structure of a connector and corresponding ground surface contact pads or other ground surface features of the PCB. The ground cage receptacle may enhance PCB interfacing by exclusively managing ground connections through an outer ground perimeter, which may eliminate the need for additional hardware while also supporting compression signal pins, such as the aforementioned pogo pins. The ground cage receptacle improves signal integrity, prevents bent pins, with respect to the pogo pins, caused by misalignment, and maintains an electrical mode of signal propagation by separating ground and signal interfaces in connector assemblies. The solution eliminates additional hardware in the form of ground pins and prevents the possibility of additionally bent pins caused by misalignment, as well as supports signal integrity by proper separation of the ground reference from data signals in the pins. In addition, the spring-loaded pins as part of a lead frame connector's internal structure and the use of a lead section and a barrel section allow for connections between two circuit boards in a right-angle topology, which is typically only possible using a two-piece male and female connector. The solution here also uses a lead frame connector which includes integration of the spring-loaded pins as part of a lead frame connector's internal structure-the lead section and the barrel section formed from a portion of the lead section, for instance. In addition to the right-angle topology, which may be one possible example which uses a two-piece male and female connector, there may be straight-through connectors that may be also supported by the lead frame connector described here.

With respect to at least differential signaling, this may be in reference to the communication or transmission of information using complementary signals over two separate conductors. In the present lead frame, connectors may represent the separate conductors. On a receiver side, a difference between the complementary signals may be used to recover the information associated with the communication or transmission. The lead frame connector herein may be used for the differential signaling with traces on a circuit board by connections between the pins and the surface contact pads of the traces. The lead frame connector may be used with differential pair conductors in a cable. For example, the lead frame connector may be used between the cable and the circuit board or between computing components, with the cable used between two lead frame connectors.

In one example, the complementary signals may include information which is transmitted on the separate conductors of the lead frame connectors, with opposite polarities. When one of the separate conductors uses a positive voltage swing, another may use a negative voltage swing of the same magnitude. The magnitude may be in reference to common-mode voltage. Differential signaling through the lead frame connectors provides advantages of improved immunity to noise which may include electromagnetic interference or crosstalk. The noise may be an issue with respect to individual ones of the separate conductors. As the information is only in a difference between the signals, the common-mode noise may cause little to no issue on the signals. Differential signaling, when used with the lead frame connectors, may support signal integrity and noise immunity for High-Speed (HS) communications, USB (Universal Serial Bus®), HDMI (High-Definition Multimedia Interface®), Ethernet®, PCI Express® (PCIe), SATA (Serial ATA), NVlink®, InfiniBand® (IB), and LVDS (Low-Voltage Differential Signaling).

The systems and methods described herein may be used for a variety of purposes, by way of example and without limitation, for machine control, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, datacenter processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed examples herein may be comprised in a variety of different systems such as, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a datacenter, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

In one example, computing devices benefiting from the lead frame connectors herein may include processors of different types. The processors may include central processing units (CPUs), graphics processing units (GPUs), data processing units (DPUs), quantum processing units (QPUs), parallel processing units (PPUs), and application-specific integrated circuits (ASICs). QPUs may be configured to perform one or more operations associated with a quantum algorithm. In some examples, each of the one or more QPUs may include qubits. One or more QPUs may be in communication with each other via a quantum channel. In some examples, each of the qubits may include local qubits, global qubits, and/or synchronization qubits. In some examples, the local qubits of each QPU may be configured to perform the one or more operations associated with the quantum algorithm on the QPU that are associated with the local qubits.

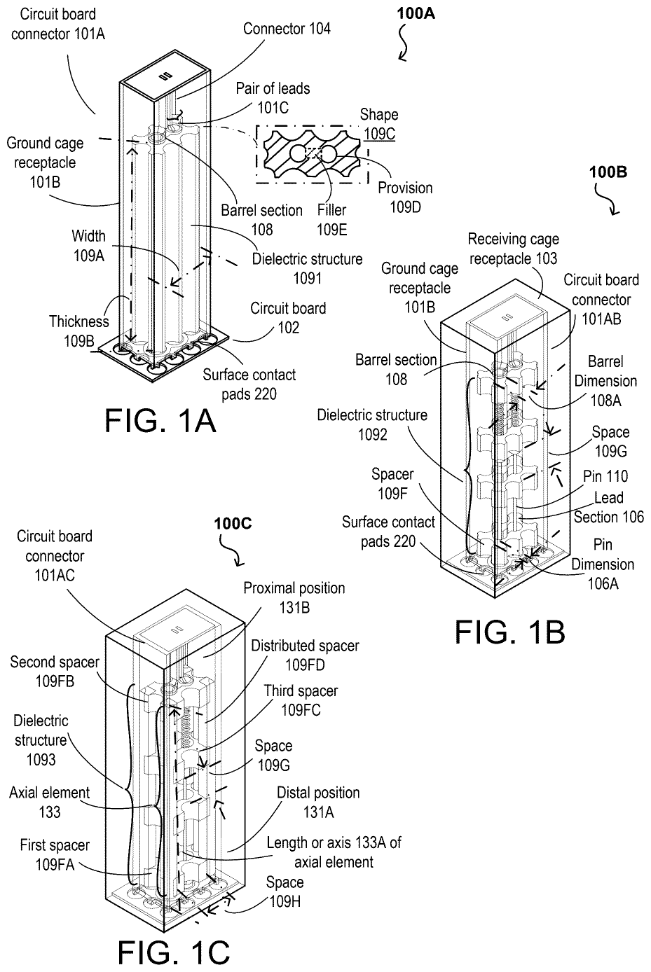

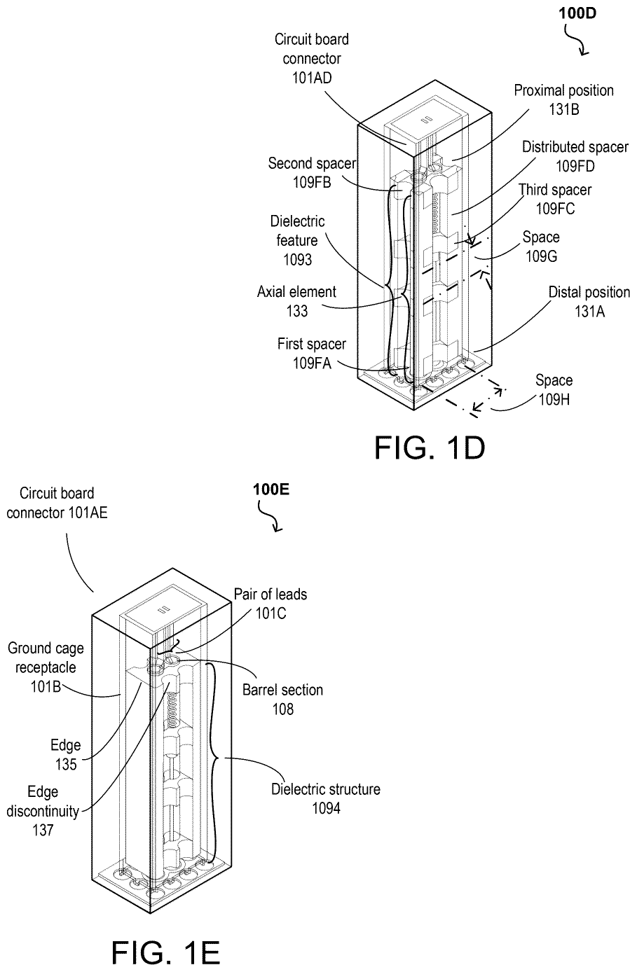

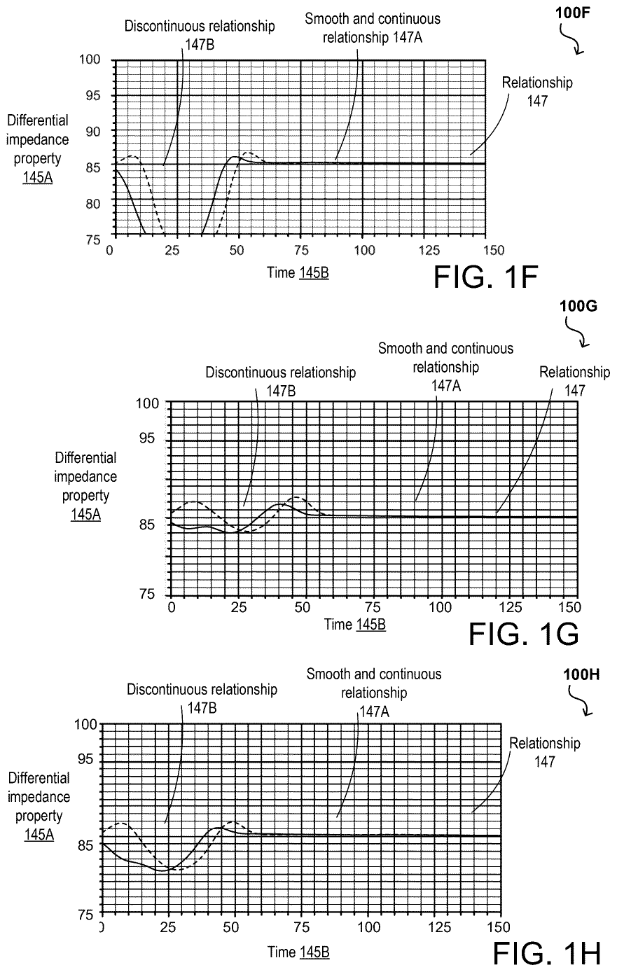

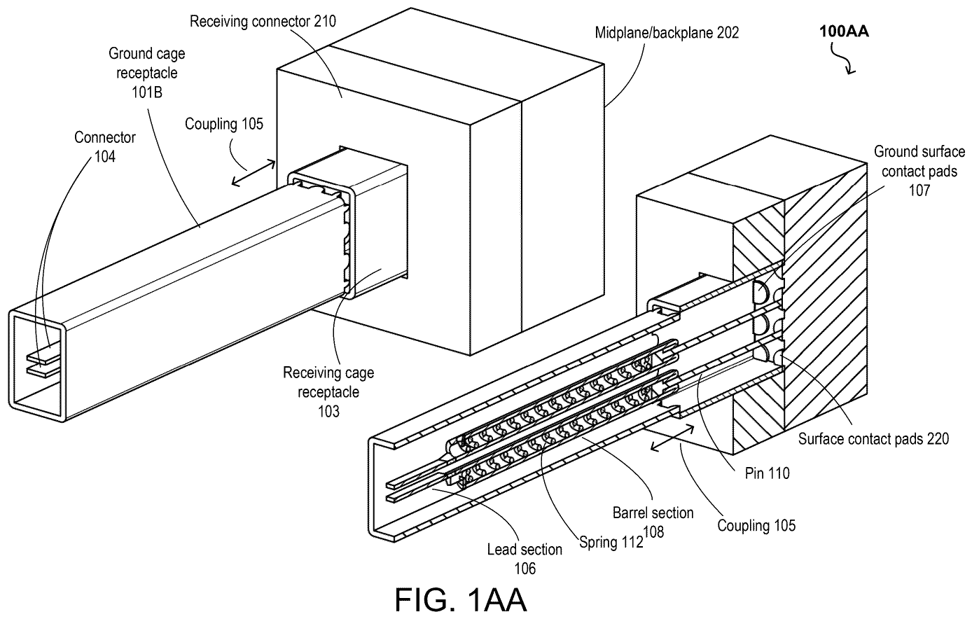

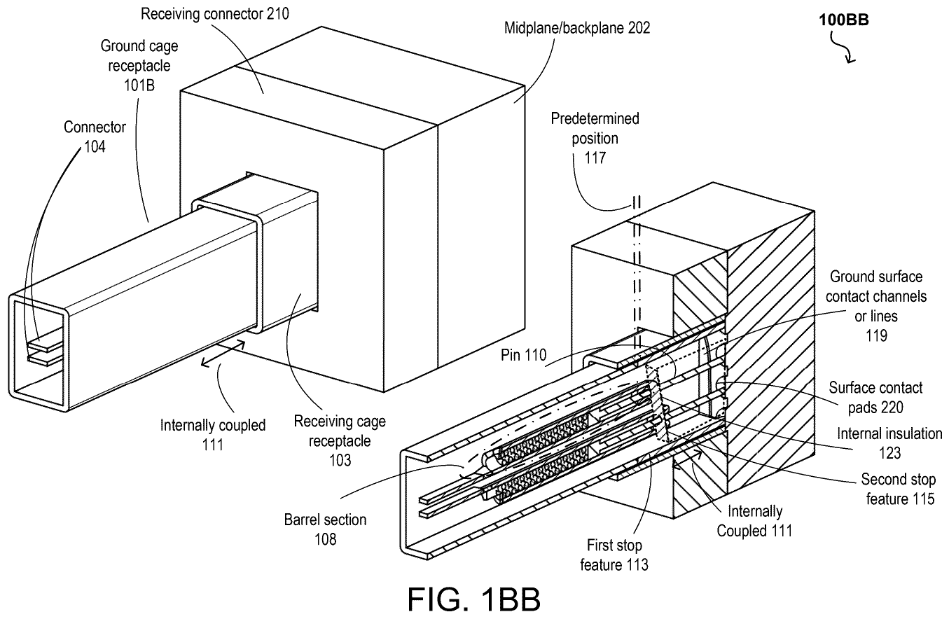

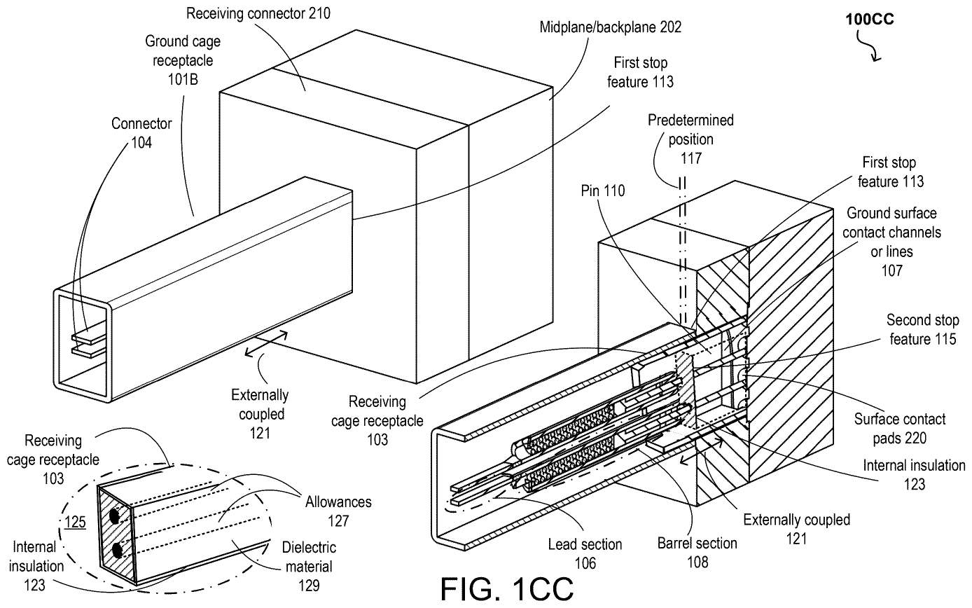

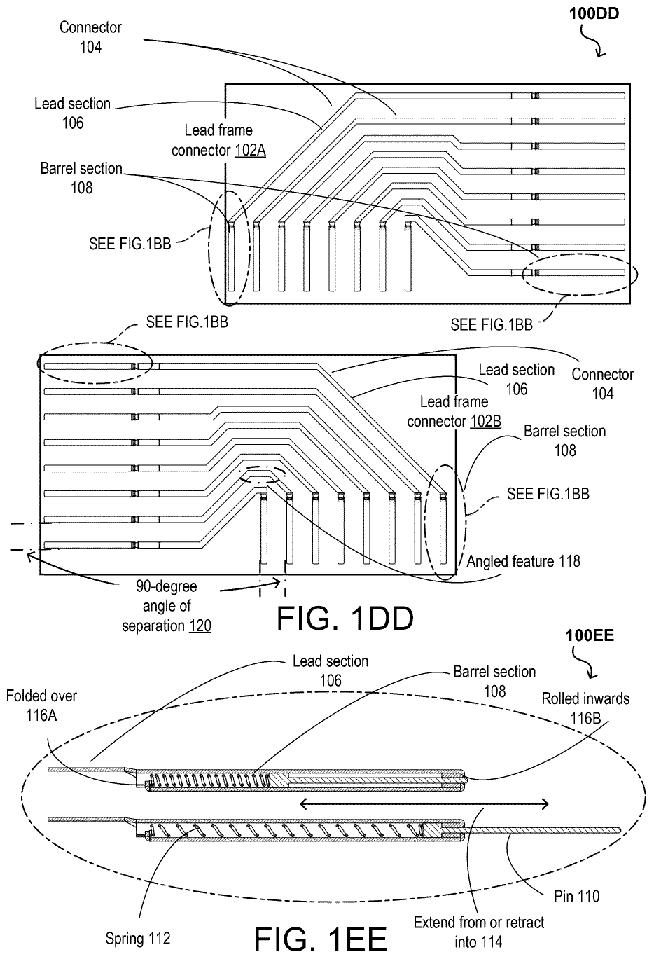

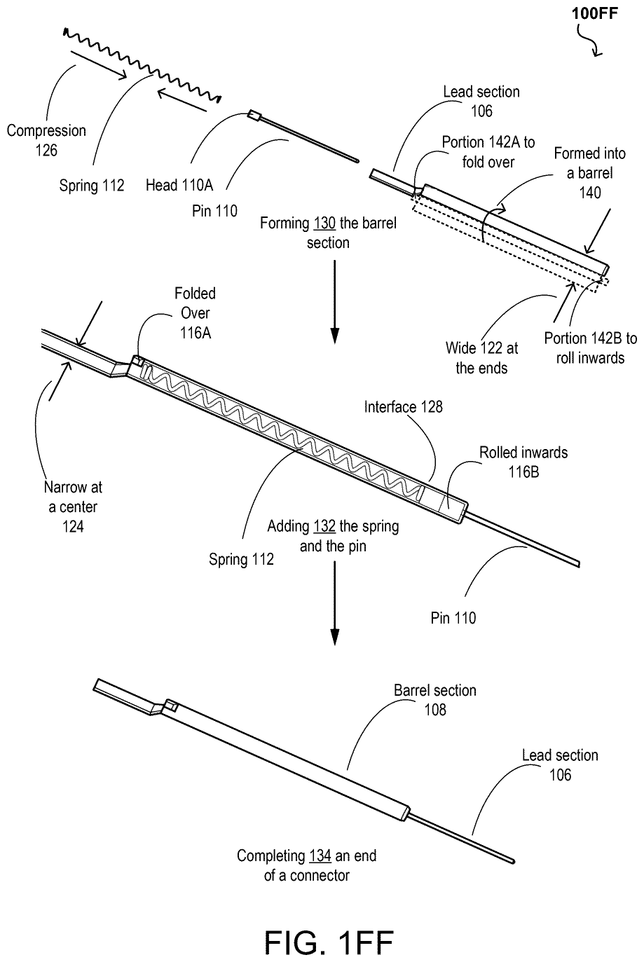

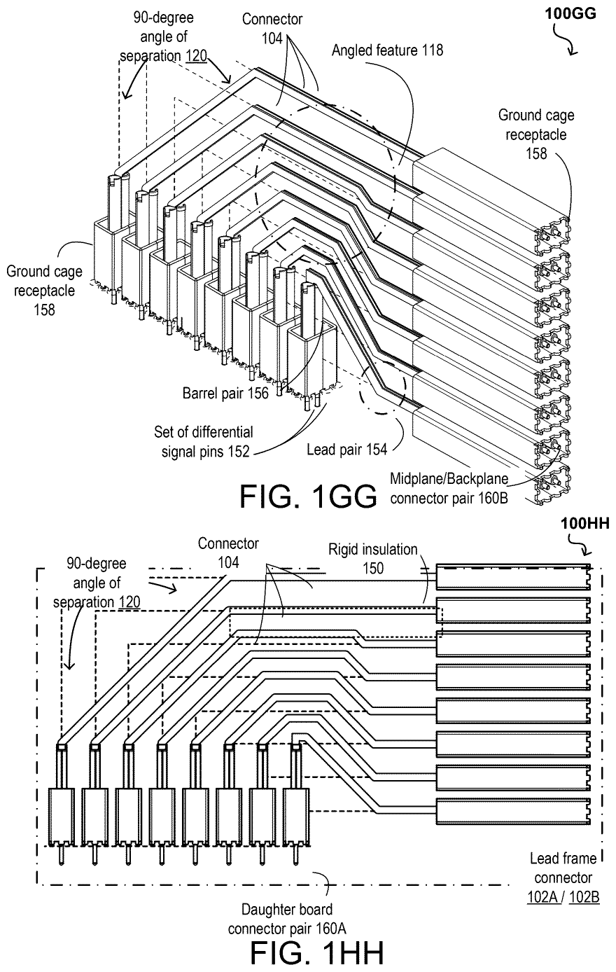

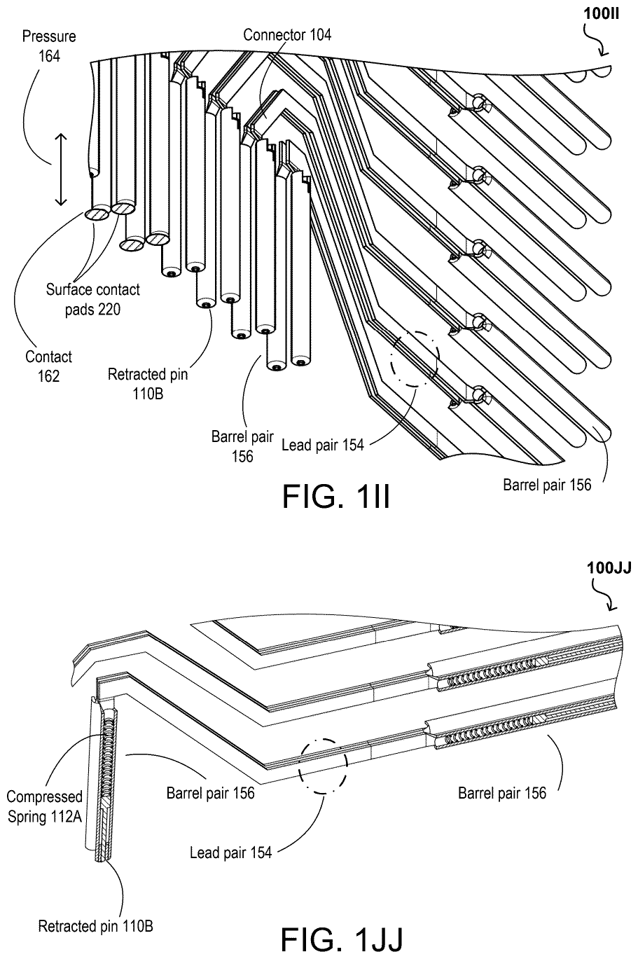

FIG. 1A illustrates details 100A of a circuit board connector having a ground cage receptacle which is separated, by one or more dielectric structures, from barrel sections and pins of a pair of leads therein, in one example. As illustrated, a circuit board connector 101A may include a ground cage receptacle 101B. The ground cage receptacle 101B may be around a pair of leads 101C. Each lead in the pair of leads 101C is represented as an individual connector 104. Each of the connectors 104 in the pair of leads 101C may include a barrel section 108 and a pin 110 (in FIG. 1B). The barrel sections of the connectors 104 may be of different dimensions, relative to the pins, as also illustrated in FIG. 1B. The ground cage receptacle 101B may be separated from the barrel sections 108 and the pins 110, taken as a pair or individually. The separation may be provided, filled, or supplemented by one or more dielectric structures 1091.

In some examples, the circuit board connector 101A allows a connection between a daughter card or daughter board 204 and a circuit board 102 of a midplane or backplane 202, as detailed further in connection with FIGS. 1AA and 2A. In some examples, the pair of leads allows a differential signaling connection, and the ground cage receptacle 101B allows a ground connection between a daughter card or daughter board 204 and a circuit board 102 of a midplane or backplane 202. In some examples, an individual lead may allow a power or signal connection between a daughter card or daughter board 204 and a circuit board 102 of a midplane or backplane 202. Each of the connections may be using one or more of the surface contact pads 220, for instance, as in FIGS. 1A-1E and 1AA-1CC.

One or more of the dielectric structures 1091 may include one or more of a dimension or shape. For example, there may be a width 109A and a thickness 109B associated with each dielectric structure 1091. In some examples, a shape 109C is illustrated (only as to the top view but is readily apparent to be the same throughout or to be varied throughout the dielectric structure 1091) and available specifically for each dielectric structure 1091. There may or may not be a filler 109E between provisions 109D for the barrel sections 108 and the pins 110. In some examples, the dielectric structure 1091 extends fully into or includes the filler 109E. The dimension and the shape for each of the dielectric structures 1091 may be predetermined based at least in part on an intended impedance profile, as described further in connection with one or more of FIGS. 1F-1H, to be maintained across the barrel sections 108 and the pins 110.

FIG. 1B illustrates another example 100B of dielectric structures usable in a circuit board connector, relative to FIG. 1A, and having a different dimension or shape which is predetermined based at least in part on an intended impedance profile. The circuit board connector 101AB of FIG. 1B may be similar to the circuit board connector 101A of FIG. 1A. The circuit board connector 101AB may include a different dielectric structure 1092, at least by virtue of the different dielectric structure 1092 including separations or spacers 109F. For example, each of the dielectric structures 1092 in a circuit board connector 101AB may include individual spacers 109F with predetermined spacing or space 109G therebetween. In some examples, the space 109G includes, represents, or is part of an air gap allowed as part of the dielectric structure 1092. The individual spacers 109F may include individual predetermined dimensions, such as width and length, along with a predetermined shape, which variations are readily apparent from the descriptions of the width 109A, thickness 109B, and shape 109C in FIG. 1A. In some examples, the predetermined dimensions may include a length of about 1.04 millimeters (mm) and a width of about 0.64 mm.

Each of the predetermined space, predetermined dimension, and the predetermined shape may be based in part on the intended impedance profile, as described further in connection with one or more of FIGS. 1F-1H, to be maintained across the barrel sections 108 and the pins 110. In addition, FIG. 1B also illustrates that the barrel sections 108 of the connectors 104 may be of a first dimension or barrel dimension 108A and that the pins 110 may be of a second dimension or a pin dimension 106A. The barrel dimension 108A and the pin dimension 106A may represent different dimensions, relatively, in the barrel section 108 and in the lead section 106, and which may benefit from the one or more dielectric structures 1091, 1092, used in the circuit board connectors 101A, 101AB. FIG. 1B also illustrates that the circuit board connector 101A, 101AB may couple to a respective receiving connector 210, such as from a midplane or a backplane 202, in FIG. 1AA.

FIG. 1C illustrates another example 100C of dielectric structures usable in a circuit board connector and having a different dimension or shape which is predetermined based at least in part on an intended impedance profile. FIG. 1C illustrate an example circuit board connector 101AC having individual spacers 109FA, 109FB, 109FC forming a dielectric structure 1093. There may be a first spacer 109FA located in a distal position 131A with respect to a first end of the pair of leads 101C. There may be a second spacer 109FB located in a proximal position 131B with respect to a second end of the pair of leads 101C. There may be a third spacer 109FC or multiple third spacers located in a middle position with respect to the first end and the second end of the pair of leads 101C.

FIG. 1C also illustrates that the individual spacers 109FA, 109FB, 109FC may include one of different predetermined thicknesses 109B as part of the dimension or shape for a dielectric structure 1093, in the circuit board connector 101AC, relative to the circuit board connectors 101A, 101AB, and the dielectric structures 1091, 1092, in FIGS. 1A and 1B. Individual ones of the different predetermined thicknesses 109B across the spacers 109FA, 109FB, 109FC, or a dielectric structure 1091, 1092, 1093 may be associated with different impedance profiles, as described further in connection with one or more of FIGS. 1F-1H, and as available to be maintained across the barrel sections 108 and the pins 110. In some examples, the predetermined thickness may be a value of about 0.30 mm. As described, while there are three spacers discussed, FIG. 1C includes four or more spacers and some of the spacers may be taken collectively to achieve aspects described herein with respect to at least the impedance profiles. For instance, there may be a third spacer 109FC or multiple third spacers located in a middle position with respect to the first end and the second end of the pair of leads 101C.

In addition, FIG. 1C also illustrates that one or more of the dielectric structures 1093 may include an axial element 133 associated with a distributed spacer 109FD. There may be multiple such distributed spacers 109FD at corners and at mid-sections of the ground cage receptacle 101B. There may be between four to eight distributed spacers 109FD, in some examples. The axial element 133 may extend substantially along a length or axis 133A which includes the barrel sections 108 and the pins 110. The distributed spacer 109FD may include a same predetermined spacing or space 109H therebetween. This predetermined space 109H may be based in part on the intended impedance profile, as described further in connection with one or more of FIGS. 1F-1H, to be maintained across the barrel sections 108 and the pins 110. FIGS. 1A-1C also illustrates that the spacers 109FA, 109FB, 109FC may be of different thicknesses in different circuit board connectors 101A, 101AB, 101AC. The different thicknesses may be also based in part on the different impedance profiles intended for the different circuit board connectors 101A, 101AB, 101AC, as described further in connection with one or more of FIGS. 1F-1H.

FIG. 1D illustrates yet another example 100D of dielectric structures usable in a connector and having a different dimension or shape which is predetermined based at least in part on an intended impedance profile. FIG. 1D illustrates that the spacers 109FA, 109FB, 109FC in the circuit board connector 101AD may be of different shapes, such as in relation to the shapes of the spacers 109FA, 109FB, 109FC in the other circuit board connectors 101A, 101AB, 101AC in FIGS. 1A-1C. In addition to the different shapes, the spacers 109FA, 109FB, 109FC are illustrated with different dimensions, such as different thickness and/or width. FIG. 1D also illustrates that the one or more dielectric structures may include different axial elements 133 of the distributed spacers 109FD. The distributed spacers 109FD may include axial elements 133 which are at individual corners of the ground cage receptacle 101B. Individual ones of the axial elements 133 extend substantially along a length which includes the barrel sections 108 and the pins 110. In some examples, the individual ones of the axial elements 133 may extend laterally across a length of the ground cage receptacle 101B.

FIG. 1E illustrates a further example 100E of dielectric structures usable in a connector and having a different dimension or shape which is predetermined based at least in part on an intended impedance profile. In the example 100E, relative to FIGS. 1A-1D, the dielectric structure 1094 may occupy the separation between the ground cage receptacle 101B and the barrel sections 108 and the pins 110, taken as a pair or individually. This example 100E may be devoid of or independent of spacers otherwise used in the other examples of FIGS. 1A-1D. In addition, the dielectric structure 1094 may have different shapes all throughout the separation, even if used as an individual and a single or integrated structure.

In some examples, a dielectric structure 1091, 1092, 1093, 1094 may be resiliently movable or deformable when the circuit board connector 101A, 101AB, 101AC, 101AD, 101AE is associated with a receiving connector 210 of a circuit board 102, such as a midplane or a backplane 202. In some examples, the one or more dielectric structures are from a material such as Teflon® or comprising Teflon or other polytetrafluoroethylene (PTFE). In some examples, a dielectric structure 1091, 1092, 1093, 1094 may include an edge 135. In some examples, the edge 135 may be or may include an edge discontinuity 137, representing a discontinuous edge, along a boundary of the dielectric structure 1091, 1092, 1093, 1094. The boundary may be within the ground cage receptacle 101B and may include at least one air gap (such as within an arch which forms the edge discontinuity 137) within the dielectric structure 1091, 1092, 1093, 1094 and between the pair of leads 101C.

In some examples, a dielectric structure 1091, 1092, 1093, 1094, whether a single or integrated dielectric material or individual spacers (or wafers), may be machined to fit the diameters of the barrel section 108 and the pins 110. For example, dimensions of the ground cage receptacle 101B may be used as a basis to machine the dielectric structure 1091, 1092, 1093, 1094 to be a predetermined measure (such as in millimeters) less than the dimensions of the ground cage receptacle 101B. In addition, a number of spacers and the thickness of the spacers may be optimized. The optimization may be in part or associated with a required characteristic or intended impedance profile of the pair of leads 101C. For example, once the impedance profile, such as in FIGS. 1G-1H, is determined for an application, the dielectric structure 1091, 1092, 1093, 1094 of the predetermined measure may be provided for a circuit board connector of the application. In some examples, the dielectric structure 1091, 1092, 1093, 1094 may have rigid properties to perform as rigid membranes for mechanical support along a length of each connector 104 of the pair of leads 101C uniting the wafers. In some examples, the dielectric structure 1091, 1092, 1093, 1094 may include the spacers which are united therein, as a single or integrated feature. In some examples, material may be removed or added to the spacers, in the form of the axial elements, to provide mechanical support (such as to form posts) and to also provide further tuning to the electrical performance of the circuit board connector. In some examples, the dielectric structure 1091, 1092, 1093, 1094 may be formed from molding or milling, instead of machining.

In some examples, FIGS. 1B-1E also illustrate a receiving connector 210 which includes a receiving cage receptacle, as detailed and described further in at least FIGS. 1AA-1CC. The receiving cage receptacle 103 (in FIG. 1AA, for instance) may be provided on a circuit board 102. The receiving cage receptacle 103 may not extend fully over the ground cage receptacle 101B, even if illustrated in some examples, as in FIGS. 1B-1E. The receiving connector 210 may be to receive an applied circuit board connector 101AB (which may be a circuit board connector that is applied against the receiving connector). The applied circuit board connector 101AB may have a ground cage receptacle 101B which is around a pair of leads 101C. The pair of leads 101C may include barrel sections 108 and pins 110. The barrel sections 108 may be of different barrel dimensions 108A relative to pin dimensions 106A of the pins 110. The ground cage receptacle 101B may be separated from the barrel sections 108 and the pins 110 by one or more dielectric structures 1092. The one or more dielectric structures 1092 may include one or more of a dimension or shape (such as dimensions 109A, 109B, and shape 109C) which is predetermined based at least in part on an intended impedance profile, as in FIGS. 1F-1H. The intended impedance profile, as in FIGS. 1F-1H may be maintained across the barrel sections 108 and the pins 110, and with respect to the receiving cage receptacle 103 or a ground of the circuit board, represented at least in part by at least some of the surface contact pads 220.

FIG. 1F illustrates an intended impedance profile 100F from the dielectric structures in the circuit board connector of FIG. 1A. The intended impedance profile is to be maintained across the barrel sections and the pins, while providing mechanical support suitable to prevent damage to the barrel sections and the pins from coupling, uncoupling, or other movements associated with the circuit board connector (or the circuit boards having the circuit board connector therebetween). In some examples, the intended impedance profile 100F may be reflected in a relationship 147 of a differential impedance property 145A, of the dielectric structure 1091, taken against a time 145B measure. The time 145B may be in picoseconds (ps). The differential impedance property 145A may include impedance, from the perspective of a differential signal driven across the pair of leads 101C. In some examples, the differential impedance property 145A may include an odd-mode impedance of each connector within the pair of leads 101C.

The odd-mode impedance may be in reference to a single connector 104 of a pair of leads 101C. The off-mode impedance may be the impedance of the single connector 104 of the pair of leads 101C when the single connector 104 is driven with signals of equal magnitude and opposite polarity. In some examples, the differential impedance property 145A may include a Time Domain Reflectometry (TDR). TDR may be used to measure impedance (including differential impedance represented by the two lines of the relationship 147) of the connector 104 (or circuit board connector 101A, 101AB, 101AC, 101AD, 101AE), as a function of time 145B. In some examples, TDR may include the provision of a pulse through the connector and tracking of the relationship 147 with respect to reflections associated with the provided pulse. The relationship 147 may be used to build an impedance profile associated with impedance changes. The impedance profile may be considered an intended impedance profile 100F when retained and used with a specific application of the circuit board connector 101A, 101AB, 101AC, 101AD, 101AE.

In some examples, an intended impedance profile 100F allows visualization of variations in a differential impedance property 145A, along a length of a pair of leads 101C, as a function of time 145B. A smooth and consistent relationship 147A may be indicative of a level of control, with respect to an intended differential impedance, for a pair of leads 101C. The smooth and consistent relationship 147A may be at a target impedance. Relatively, a discontinuous relationship 147B may include rises and dips, indicative of deviations from the target impedance. The discontinuous relationship 147B may be indicative of impedance discontinuities. In some examples, the impedance discontinuities may be at least because of ground reference differences provided through the ground cage receptacle 101B, using the dielectric structure 1091, 1092, 1093, 1094 between the ground cage receptacle 101B and the pair of leads 101C. For example, the different dimensions and shapes of the dielectric structure 1091, 1092, 1093, 1094, including thickness and properties of the materials (such as for the different spacers) may induce the ground reference differences, as part of the intended impedance profile 100F for an application.

In some examples, the intended impedance profile 100F allows determination of a discontinuous relationship 147B which is within a tolerance suitable to an application. For example, ground reference differences contributing to impedance variation of about ±5%, ±10%, or other predetermined tolerances may be allowed for specific high-speed interconnects. The intended impedance profile 100F allows determination of specific dielectric structure 1091, 1092, 1093, 1094 to provide mechanical support for an application of the circuit board connector 101A, 101AB, 101AC, 101AD, 101AE, while also providing differential impedance acceptable for the application. In at least FIG. 1F, the intended impedance profile 100F may be for a dielectric structure 1091, in FIG. 1A, that is continuous and without spacers. While providing mechanical support throughout the length of a pair of leads 101C, the dielectric structure 1091 may be useful for certain applications that may be other than the high-speed interconnects or differential signaling.

FIG. 1G illustrates an intended impedance profile 100G from the dielectric structures in the connector of FIG. 1B. The discussion about the representations in the intended impedance profile 100F is also applicable to the intended impedance profile 100G in FIG. 1G and is incorporated by reference with respect to the intended impedance profile 100G in FIG. 1G. In addition, the intended impedance profile 100G may be for a dielectric structure 1092, in FIG. 1B, that is discontinuous and with spacers 109F. As illustrated, the intended impedance profile 100G has a less prominent discontinuous relationship 147B at lower times 145B and has a reasonably smooth and consistent relationship 147A, with respect to a differential impedance property 145A. While providing mechanical support at least at a distal, a proximal, and a middle portion of the length of a pair of leads 101C, the dielectric structure 1092, by virtue of a less prominent discontinuous relationship 147B, may be within tolerances for use with certain applications that include high-speed interconnects or differential signaling.

FIG. 1H illustrates an intended impedance profile 100H from the dielectric structures in the connector of FIG. 1C. The discussion about the representations in the intended impedance profile 100F is also applicable to the intended impedance profile 100H in FIG. 1F and is incorporated by reference with respect to the intended impedance profile 100H in FIG. 1H. In addition, the intended impedance profile 100H may be for a dielectric structure 1093, in FIG. 1C, that is discontinuous and with spacers 109F, including distributed spacers 109FD. As illustrated, the intended impedance profile 100H has a less prominent discontinuous relationship 147B at lower times 145B, relative to the intended impedance profile 100F of FIG. 1F, but has a more prominent discontinuous relationship 147B at lower times 145B than the intended impedance profile 100G of FIG. 1G. In addition, the intended impedance profile 100H has a reasonably smooth and consistent relationship 147A, with respect to a differential impedance property 145A. While providing additional mechanical support by the distributed spacers 109FD, in addition to the spacers 109F at at least the distal, the proximal, and the middle portion of the length of a pair of leads 101C, the dielectric structure 1093, by virtual of a medium prominence in its discontinuous relationship 147B, may also be within tolerances for use with certain applications that include high-speed interconnects or differential signaling.

The circuit board connector 101A, 101AB, 101AC, 101AD, 101AE may be such that it is part of an array of circuit board connectors forming a lead frame connector, such as described in connection with FIGS. 1DD, 2A, and 2B. In some examples, the lead frame connector may be between a first circuit board and a second circuit board or computing component, such as a daughter board or card and a midplane or backplane, as in these FIGS. Further, the dimension or shape of the dielectric structure 1091, 1092, 1093, 1094 may be predetermined to allow or support a less than one percent deviation in a practical application of an impedance profile, with respect to the intended impedance profile. In some examples, a lead frame connector may be subject to forces and pressures required for coupling, decoupling, and maintenance of the coupling between the first circuit board and the second circuit board. The forces and pressures may be taken into consideration with respect to type of dielectric structure 1091, 1092, 1093, 1094 used, in addition to the differential impedance intended for the application of the lead frame connector at least because of the intended impedance profiles 100F-H generated and maintained with respect to the different types of dielectric structure 1091, 1092, 1093, 1094 available. In some examples, the intended impedance profiles 100F-H also allow for variations to the shapes and dimensions of the dielectric structure 1091, 1092, 1093, 1094 by being a reference for an intended impedance profile, for example.

In some examples, while there are different circuit board connectors 101A, 101AB, 101AC, 101AD, and 101AE described herein, an individual lead frame connector, as illustrated and described with respect to FIGS. 1DD, 1GG, 2A, and 2B, may use the same circuit board connectors with the same type of dielectric structure. A same type of the dielectric structure may include the same thickness, the same width, the same shape, the same spacing (when provided), and the same spacers (when provided). In some examples, different circuit board connectors 101A, 101AB, 101AC, 101AD, and 101AE described herein may be used within an individual lead frame connector, as illustrated and described with respect to FIGS. 1DD, 1GG, 2A, and 2B, to achieve a mixed impedance profile. For example, different signaling and/or power may be achieved within a single lead frame connector, providing the different (or different types of) dielectric structures for different leads or lead pairs. In some examples, while different thickness, width, shape, spacing (when provided), and spacers (when provided), as described, each use case may require symmetry in the different thickness, width, shape, spacing (when provided), and spacers (when provided), for individual connectors, individual circuit board connectors, or individual lead frame connectors. The dielectric structure 1091, 1092, 1093, 1094 may include any suitable dielectric material but may, in some examples, use a dielectric material which is resiliently movable or deformable.

In some examples, FIGS. 1A-1H, supported by FIGS. 1AA, 1DD, 2A, and 2B illustrate a system for a lead frame connector 102A, 102B. The system may include multiple ground cage receptacles 101B as part of multiple circuit board connectors 101A, 101AB, 101AC, 101AD, 101AE, which may be part of the lead frame connector 102A, 102B. The system may include lead sections 106 having individual pairs of leads 101C within individual ones of the ground cage receptacles 101B. A pair of leads 101C may include barrel sections 108 and pins 110. The barrel sections 108 may be of different dimensions (such as barrel dimension 108A) relative to the pins (such as having pin dimension 106A). The individual ones of the ground cage receptacles 101B may be separated from respective barrel sections 108 and respective pins 110 by one or more dielectric structures 1091, 1092, 1093, 1094. The one or more dielectric structures 1091, 1092, 1093, 1094 may include one or more of a dimension or shape (such as dimensions 109A, 109B, and shapes 109C), which may be predetermined based at least in part on an intended impedance profile, such as in FIGS. 1F-1H, to be maintained across the barrel sections 108 and the pins 110.

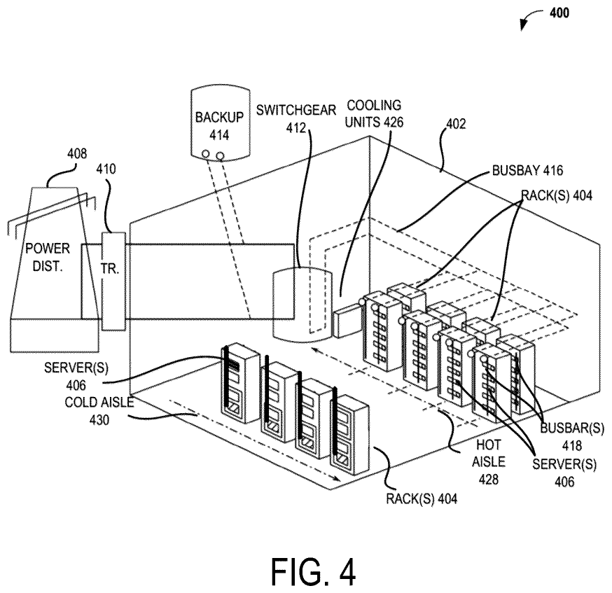

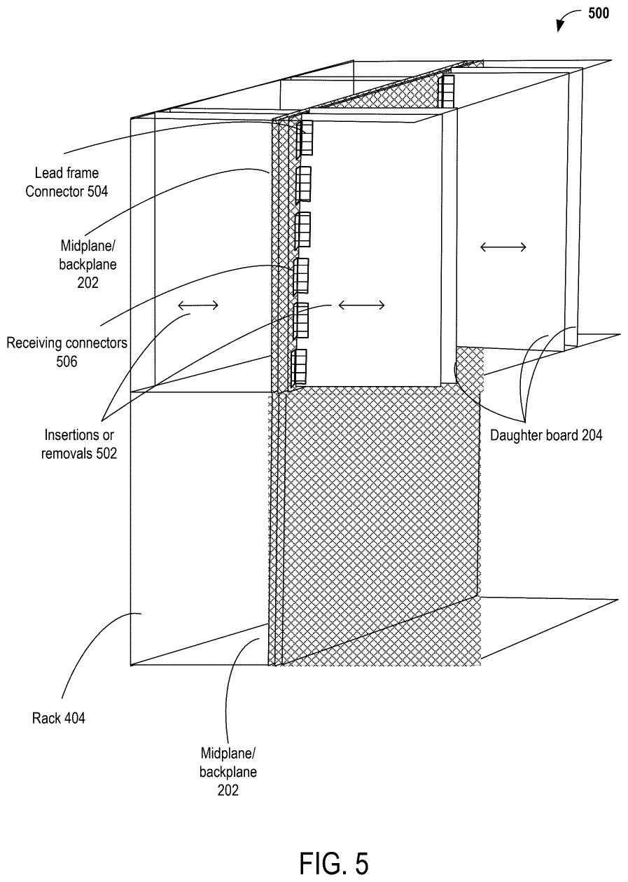

In some examples, FIGS. 1A-1H, supported by FIGS. 1AA, 1DD, 2A, 2B, 4, and 5 illustrate a datacenter (such as a datacenter 400 in FIG. 4 having the aspects 500 in FIG. 5 of a rack 404) using lead frame connectors 102A, 102B. The datacenter may include a midplane or a backplane 202. The midplane or backplane 202 may include signal surface contact pads and ground surface contact pads, such as part of the surface contact pads 220 in FIGS. 1A, 1B. In some examples, instead of the surface contact pads for at least the ground reference, channels, or lines may be available. The datacenter may include one or more daughter boards 204 coupled to the midplane or backplane 202 through a lead frame connector 102A, 102B. The lead frame connector 102A, 102B may include ground cage receptacles 101B. The lead frame connector 102A, 102B may include lead sections 106 having individual pairs of leads 101C within individual ones of the ground cage receptacles 101B. A pair of leads 101C may include barrel sections 108 and pins 110. The barrel sections 108 may be of different dimensions (such as barrel dimension 108A) relative to the pins (such as having pin dimension 106A). The individual ones of the ground cage receptacles 101B may be separated from respective barrel sections 108 and respective pins 110 by one or more dielectric structures 1091, 1092, 1093, 1094. The one or more dielectric structures 1091, 1092, 1093, 1094 may include one or more of a dimension or shape (such as dimensions 109A, 109B, and shapes 109C), which may be predetermined based at least in part on an intended impedance profile, such as in FIGS. 1F-1H, to be maintained across the barrel sections 108 and the pins 110.

FIG. 1AA illustrates regular and cross-section views 100AA of a ground cage receptacle for a lead frame connector which is to be coupled to a receiving cage receptacle, in accordance with at least some embodiments. A lead frame connector, detailed further in connection with at least FIG. 1HH, may include multiple individual connectors 104. Each of the connectors 104 may include a lead section 106 and a barrel section 108. The barrel section 108 may be formed from a portion of the lead section 106 (as illustrated and described in connection with FIG. 1FF, for instance). In another example, the barrel section 108 may be prepared separately from the lead section 106 and may be associated to the 106 lead section by a solder. The barrel section 108 may include a pin 110 and a spring 112, which are further illustrated and described in connection with FIGS. 1DD-1JJ, for instance. Each of the connectors 104 may include a ground cage receptacle 101B which is around at least the barrel section 108. The pin 110 and the spring 112 of the barrel section 108 may be used to transmit a data signal. In addition, the ground cage receptacle 101B may be for coupling 105 to a receiving cage receptacle 103 of a circuit board, which may be a midplane or backplane 202 in a datacenter. The ground cage receptacle 101B, by the coupling 105, may be able to provide a ground reference for the data signal.

In one example, the pin 110 may extend from or retract into the barrel section based in part on at least one stop feature associated with a receiving cage receptacle 103, and which is detailed further in connection with at least FIGS. 1BB, 1CC. The stop feature may also hold the ground cage receptacle 101B at a predetermined position (such as described and illustrated with respect to FIGS. 1BB, 1CC). The predetermined position may be with respect to the receiving cage receptacle 103. The predetermined position may allow the pin 110 to contact a signal surface contact pad 220 on the circuit board for transmission of the data signal to the circuit board. The signal surface contact pad 220 may be different from the ground surface contact pad 107 that couples to the receiving cage receptacle 103 and to the ground cage receptacle 101B, through the receiving cage receptacle 103. As illustrated, the signal surface contact pads 220 may be within or inside a perimeter formed by the ground surface contact pads 107. In addition, as detailed further in connection with one or more of FIGS. 1BB, 1CC, the ground surface contact pads 107 may be in the form of channels or lines 119 around the signal surface contact pad 220.

FIG. 1BB illustrates regular and cross-section views 100BB of a ground cage receptacle for a lead frame connector, with internal coupling, to a receiving cage receptacle, in accordance with at least some embodiments. In one example, a ground cage receptacle 101B fits inside the receiving cage receptacle 103 of a receiving connector 210. This may represent an internally coupled 111 interface between a connector 104 and a receiving connector. A contact between the ground cage receptacle 101B and the receiving cage receptacle 103 may allow a ground reference to a ground surface contact pad 107 of a circuit board. There may be one or more stop features associated with the receiving cage receptacle 103, in one example. For instance, a first stop feature 113 may be part of an internal insulation 123 that is within the receiving cage receptacle 103. In another example, the first stop feature 113 may be part of the receiving cage receptacle 103 itself and may allow a ground reference through the first stop feature 113 to a ground surface contact pad 107 of a circuit board. The first stop feature 113 may act on the ground cage receptacle 101B to prevent further movement between the ground cage receptacle 101B and the receiving cage receptacle 103, but also to ensure a predetermined position 117 for the ground cage receptacle 101B so that a pin 110 within the ground cage receptacle 101B is able to contact a signal surface contact pad 220 on the circuit board for transmission of the data signal to the circuit board.

A second stop feature 115 may be part of an internal insulation 123 that is within the receiving cage receptacle 103. The internal insulation 123 may also insulate between multiple pins and multiple barrel sections within a connector 104. The internal insulation 123 may also insulate between the multiple pins, the multiple barrel sections, and the ground cage receptacle. The second stop feature 115 may have allowances (such as apertures or holes) for a pin 110 to pass through but may restrict a barrel section 108 of the connector 104. The second stop feature 115 may act on the barrel section 108 of the connector 104 to prevent further movement of the barrel section 108, with respect to the receiving cage receptacle 103. The pin 110 may be allowed to extend from the barrel section 108, through the allowances in the second stop feature 115 to contact a signal surface contact pad 220 on the circuit board for transmission of the data signal to the circuit board. A location of the second stop feature 115 may be to ensure a predetermined position 117 for one or more of the ground cage receptacle 101B or the barrel section 108 so that the pin 110 of the ground cage receptacle 101B is able to contact a signal surface contact pad 220 on the circuit board for transmission of the data signal to the circuit board.

In one example, the predetermined position 117 may coincide for the first stop feature 113 and for the second stop feature 115. In another example, the predetermined position 117 may be different for one or more of the first stop feature 113 or the second stop feature 115 but may be such that the contact between the pin 110 and the signal surface contact pad 220 is at a predetermined contact application. In one example, the predetermined contact application may include one or more of a predetermined pressure or contact resistance between the pin 110 and the signal surface contact pad 220. The predetermined contact application may ensure that there is sufficient contact to support or allow high-speed signal performance for data signals therethrough, without potential interference and without damage to the circuit board or to the spring 112 or the pin 110 of the connector 104.

FIG. 1CC illustrates regular and cross-section views 100CC of a ground cage receptacle for lead frame connectors, with external coupling, to a receiving cage receptacle, in accordance with at least some embodiments. As illustrated, different than FIG. 1BB, a ground cage receptacle 101B may fit over a receiving cage receptacle 103 of a receiving connector 210. This may represent an externally coupled 121 interface between a connector 104 and a receiving connector 210. There may be one or more stop features associated with the receiving cage receptacle 103, in one example. A first stop feature 113 may be part of an external insulation that may be around the receiving cage receptacle 103 of the receiving connector 210. In another example, the first stop feature 113 may be separate from the receiving cage receptacle 103 and may be associated to the receiving cage receptacle 103. A contact between the ground cage receptacle 101B and the receiving cage receptacle 103 may allow a ground reference to a ground surface contact pad 107 of a circuit board. The first stop feature 113 may act on the ground cage receptacle 101B to prevent further movement between the ground cage receptacle 101B and the receiving cage receptacle 103, but also to ensure a predetermined position 117 for the ground cage receptacle 101B so that a pin 110 of the ground cage receptacle 101B is able to contact a signal surface contact pad 220 on the circuit board for transmission of the data signal to the circuit board.

A second stop feature 115 may be part of an internal insulation 123 that is within the receiving cage receptacle 103. The internal insulation 123 may also insulate between multiple pins and multiple barrel sections within a connector 104. The internal insulation 123 may also insulate between the multiple pins, the multiple barrel sections, and the ground cage receptacle. The second stop feature 115 may have allowances for a pin 110 to pass through but may restrict a barrel section 108 of the connector 104, as in the case of the regular and cross-section views 100BB of FIG. 1BB. The second stop feature 115 may act on the barrel section 108 of the connector 104 to prevent further movement of the barrel section 108, with respect to the receiving cage receptacle 103.

As illustrated in the callout 125 of FIG. 1CC, the pin 110 may be allowed to extend from the barrel section 108, through the allowances 127 of the internal insulation 123 having a dielectric material 129 and providing the second stop feature 115, to contact a signal surface contact pad 220 on the circuit board. The dielectric material 129 has dielectric properties which may prevent short circuits between pins 110, in one example, and which may prevent short circuits between a pin 110 and the receiving cage receptacle 103 or a ground cage receptacle 101B, in other examples. The dielectric properties may also allow maintenance of impedance control within the lead frame connector and the receiving connector. In one example, a similar internal insulation 123 may be provided for the lead section of the lead frame connector to also prevent a short circuit between the lead section and to allow maintenance of impedance control within the lead frame connector at the lead section. The contact between the pin 110 and the signal surface contact pad 220 allows for transmission of the data signal to the circuit board. A location of the second stop feature 115 may be to ensure a predetermined position 117 for one or more of the ground cage receptacle 101B or the barrel section 108 so that the pin 110 of the ground cage receptacle 101B is able to contact a signal surface contact pad 220 on the circuit board for transmission of the data signal to the circuit board.

In one example, the predetermined position 117 may coincide for the first stop feature 113 and for the second stop feature 115. In another example, the predetermined position 117 may be different for one or more of the first stop feature 113 or the second stop feature 115 but may be such that the contact between the pin 110 and the signal surface contact pad 220 is at a predetermined contact application. In one example, the predetermined contact application may include one or more of a predetermined pressure or contact resistance between the pin 110 and the signal surface contact pad 220. The predetermined contact application may ensure that there is sufficient contact to support or allow high-speed signal performance for data signals therethrough, without potential interference and without damage to the circuit board or to the spring 112 or the pin 110 of the connector 104.

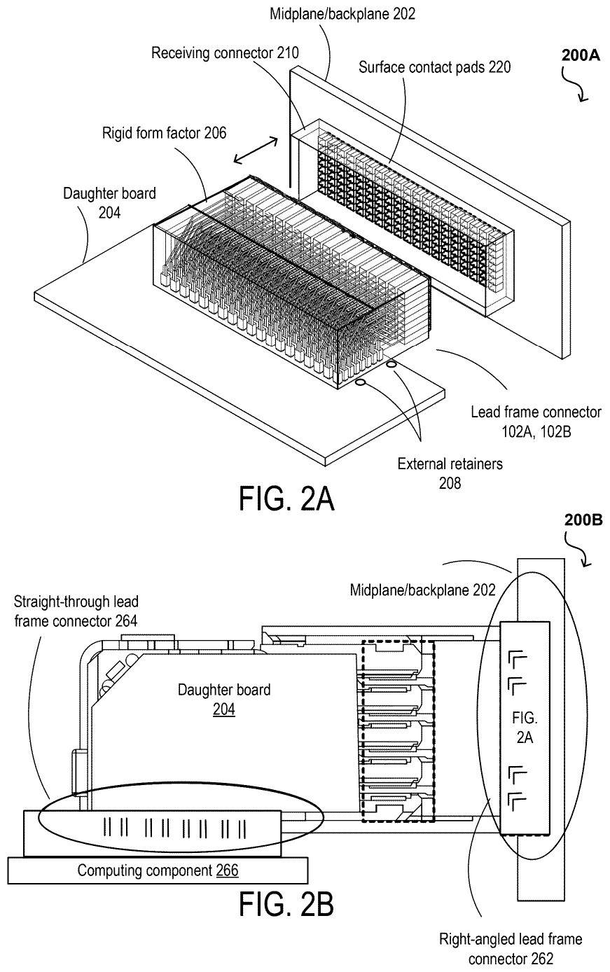

The connector 104 in FIGS. 1AA-1CC may be on a daughter board (as illustrated in at least FIG. 2A). The receiving connector 210 illustrated may be on the midplane or backplane 202 to allow receipt of the connector 104 for transmitting data signals and for providing a ground reference between the daughter board and the midplane or backplane 202. The receiving cage receptacle 103 may be soldered or affixed to ground surface contact pads 107 or to ground surface contact channels or lines 119 on the midplane or backplane 202. The signal surface contact pads 220 may be within a perimeter formed by the ground surface contact pads 107 or the ground surface contact channels or lines 119.

The connector 104 may be part of a differential signal connection with the ground reference. The data signal of the pin 110 may be one of a set of differential signals, with the pin 110 being one of a set of differential signal pins (also illustrated in the cross-sections in FIGS. 1AA-1CC). The differential signal pins may be supported by the ground reference from the ground cage receptacle 101B. The connector 104 may be such that it is part of an array of connectors, such as the 1DD array in FIG. 1GG and the 2D array in FIG. 2A. The array of connectors may form a lead frame connector, such as in FIGS. 1HH and 2A. The lead frame connector may be between the circuit board forming a midplane or backplane 202 and a further circuit board which may be a daughter board or may be between the midplane or backplane 202 and a computing component.

The connector 104 may include a lead section 106 and may include a barrel section 108 which may be coupled to or which may be formed from part of the lead section 106. The lead section 106 may allow transmission of a data signal within the connector 104. The ground cage receptacle 101B may be around the lead section 106 in addition to being around the barrel section 108, as illustrated in one or more of FIGS. 1AA-1CC. The connector 104 may include rigid insulation, as part of the external insulation having the first stop feature 113, for instance. The rigid insulation may be around the ground cage receptacle 101B to allow a rigid form factor for the connector 104.

The connector 104 may include a second barrel section to couple, through the lead section, to the barrel section, as illustrated and detailed in the examples of FIGS. 1GG-2B. The second barrel section may be coupled to a daughter board and the barrel section may be to couple to a midplane or a backplane 202 of a rack in a datacenter, such as in FIG. 5. The ground cage receptacle 101B may extend from the second barrel section to the barrel section to provide the ground reference between the daughter board and the midplane or the backplane.

The connector 104 may include parallel leads in the lead section 106, as illustrated and detailed in the examples of FIGS. 1GG-2B. The connector 104 may include parallel barrels in the barrel section, as also in the same examples. The connector 104 may include the ground cage receptacle 101B over the parallel leads and parallel barrels. The parallel barrels may include a further pin and a further spring. The pin and the further pin (of the parallel barrels) may support or allow a differential signal therebetween with the ground cage receptacle 101B to support or allow the ground reference. Further, an array of the parallel leads may allow the connector 104 to be part of a lead frame connector, as detailed with respect to FIGS. 1HH and 2A.

The connector 104 may be such that the ground cage receptacle 101B includes a copper alloy, in one example. The receiving connector 210 may be such that the receiving cage receptacle 103 may also include a copper alloy, in one example. This may at least allow a predetermined contact for ground reference for the data signal. The connector 104 may also include a lead section 106 and the ground cage receptacle 101B having an angled feature that may be independently provided for each of the lead sections and the ground cage receptacle 101B. The angled feature, which is detailed further in at least FIGS. 1GG and 1HH may allow a 90-degree angle of separation between the barrel section 108 of the connector 104 and another barrel section of another connector, as also in these figures.

FIGS. 1AA-1CC also illustrate, along with FIGS. 1DD-7, a system for a lead frame connector having multiple ground cage receptacles. In one example, at least the array of the connectors in FIGS. 1GG-2B may include the multiple ground cage receptacles. There may be multiple barrel sections having pins and springs, such as a set of differential signal pins, within the multiple ground cage receptacles. Further, individual ones of the ground cage receptacles may be around individual pairs of the barrel sections. The ground cage receptacles couple to receiving cage receptacles of a circuit board to provide ground references for data signals through the pins and the springs. The pins are to extend from or retract into respective ones of the barrel sections based in part at least on respective stop features 113, 115 associated with respective ones of the receiving cage receptacles. In one example, respective stop features 113, 115 may hold respective ground cage receptacles at a predetermined position 117 with respect to the receiving cage receptacles. In another example, the respective stop features 113, 115 may allow the pins to contact signal surface contact pads on the circuit board for transmission of the data signals to the circuit board.

FIGS. 1AA-1CC also illustrate, along with FIGS. 1DD-7, a receiving connector 210 having a receiving cage receptacle 103 and a stop feature 113, 115 associated with the receiving cage receptacle 103. The receiving cage receptacle 103 may be affixed to a circuit board, as also illustrated in FIGS. 1AA-1CC. The stop feature 113, 115 may hold a ground cage receptacle of an applied connector 104 at a predetermined position 117 with respect to the receiving cage receptacle 103 and may allow a pin 110 of the applied connector 104 to contact a signal surface contact pad 220 on the circuit board for transmission of the data signal to the circuit board. The receiving cage receptacle 103 may couple to a ground cage receptacle 101B of the applied connector 104 for provision of a ground reference between the receiving connector 210 and the applied connector 104.

FIG. 1DD illustrates different lead frame connectors 100DD having a lead section and a barrel section, in accordance with at least some embodiments. In one example, each lead frame connector 102A, 102B may include a series of connectors 104. Each connector 104 may include a lead section 106 and a barrel section 108, as discussed in connection with FIGS. 1AA-1CC. The barrel section 108 may be formed from a portion of the lead section 106 (as illustrated and described in connection with FIG. 1FF, for instance). The barrel section 108 may include a pin and a spring, as illustrated and described in connection with FIGS. 1EE, 1FF, for instance.

FIG. 1DD also illustrates that the barrel section 108 may include a barrel formed from the lead section 106. In one example, the lead section 106 may be part of a strip of material having wider portions at its ends. The material may be 0.05 mm thick along its longest length and with a length suitable to reach opposite ends of a lead frame connector 102A, 102B at its longest length. The material may be wide 122 at both ends of the longest length and may be narrow 124, relative to the width 122, at a center of the longest length. The material may include one or more of a copper alloy or nickel plating. The pin may be formed by one or more of a copper alloy or gold plating. The spring may be formed from stainless steel. All such materials are conductive. The barrel section 108 may allow an electrical connection from the pin and through the barrel section to pass the signals or power from the circuit board through the connector.

FIG. 1DD also illustrates that each lead section 106 may include an angled feature 118. The angled feature may include one or more angles therein, as illustrated. The angled feature 118 may be to allow a 90-degree angle of separation 120 between the barrel sections 108 of the same connectors 104 and another barrel section of another connector, as illustrated. The one or more angles may be provided to enable a suitable traversal of multiple lead sections within a space available for the lead frame connector 102A, 102B.

FIG. 1EE illustrates cross-section views 100EE of a lead frame connector having a lead section and a barrel section, in accordance with at least some embodiments. The wider portions, as described with respect to FIG. 1DD and illustrated in FIG. 1FF, may be folded into the barrel. In addition, the strip of material having the wider portions may include portions at a top and at a bottom of the barrel. The portion at the top of the barrel may be folded over 116A at an opening of the barrel to prevent the spring 112 from exiting the barrel from the top. The pin 110 (such as in FIG. 1EE) may be compressed from the bottom of the barrel. The portion at the bottom of the barrel may be folded or rolled inward 116B to also prevent the pin from being ejected once the pin is depressed. This provides the barrel section 108 of the connector 104. The connector 104 may be used against surface contact pads of a backplane or a midplane, along with other similar connectors, as detailed further in FIGS. 1EE-7.

FIG. 1FF illustrates process details 100FF of a barrel section having a pin and a spring, in accordance with at least some embodiments. As illustrated, a first step may include forming 130 the barrel section 108 using a width of material that is narrow 124 at the center and that is wide 122 at its ends. The wide 122 material may be suitable or predetermined to allow the ends to be formed into a barrel 140, as part of the forming 130 step. The process details 100FF illustrate that a step of adding 132 the spring and the pin may be performed. The pin 110 and the spring 112 may be inserted through a top or a bottom of the barrel with a head 110A of the pin 110 to interface 128 with the spring 112. The spring may have a compression 126 capability to allow the insertion into the barrel.

A portion 142A of the top of the barrel may be folded over 116A an opening of the barrel once the spring 112 is inserted to prevent the spring 112 from exiting the barrel from the top. The pin 110 may be separately provided from a bottom of the barrel and may be provided to compress the spring from the bottom. A portion 142B of the bottom of the barrel may be rolled inwards 116B to also prevent the pin 110 from being ejected once the pin 110 has depressed the spring 112. This completes 134 or provides the barrel section 108 of the connector 104. The connector 104 may be used against surface contact pads of a backplane or a midplane, along with other similar connectors, as detailed with respect to one or more of FIGS. 1GG-7.

FIG. 1GG is a perspective view 100GG of an angled feature to allow a 90-degree angle of separation between the barrel sections of a connector that is part of the lead frame connectors, in accordance with at least some embodiments. FIG. 1GG illustrates that there may be a set of connectors 104 running together, as part of a differential signal connection, with at least two pins 110 being a set of differential signal pins 152. Each of the connectors may be part of an array of connectors, such as the 1-dimensional (1DD) array illustrated, but capable of supporting at least 2-dimensional (2D) arrays, as illustrated in at least FIG. 2A. The 1DD or 2D arrays may form a lead frame connector 102A, 102B that may be between a circuit board and a further circuit board or a computing component. Two connectors 104 may be aligned to form a pair of connectors having at least one barrel pair 156 and a lead pair 154. There may be at least two barrel pairs 156 for each lead pair 154, with each barrel pair 156 being on an end of the lead pair 154. In addition, the ends may be supported by angled features 118 which allow a 90-degree angle of separation 120 between the barrel sections 108 of the connectors 104.

Each connector 104 may be such that its lead section 106 may be part of a lead pair 154 and may include an insulation media between the lead pair 154. In one example, the insulation media may be air. In another example, a rigid insulation 150 may be provided around the lead section 106 and may extend over the barrel section 108. The rigid insulation 150 may allow a rigid form factor 206 for the connector and may allow a rigid form factor for the array of connectors to form a lead frame connector 102A, 102B. The lead section 106 may include the lead pair 154 in a formation of parallel leads. The parallel leads may have parallel barrels in the barrel section 108. In one example, the parallel barrels form a barrel pair 156, which may include a further pin and a further spring. The pins from the barrel pair 156 may be a set of different signal pins that are to support or allow a differential signal therebetween. FIG. 1GG may include a 1DD array of parallel leads (in the lead pair 154, for instance) to allow the connector 104 to be part of a lead frame connector 102A, 102B.

FIG. 1HH is a side view 100HH of an angled feature to allow a 90-degree angle of separation between the barrel sections of a connector that is part of a lead frame connector, in accordance with at least some embodiments. The 90-degree angle of separation 120 between the barrel sections 108 of individual connectors 104 allows a lead frame connector 102A, 102B to couple between circuit boards that are perpendicular to each other, between computing components that are perpendicular to each other, or between a circuit board and a computing component that are perpendicular to each other. The connectors 104 may include rigid insulation 150 throughout the lead sections 106, although a ground cage receptacle 158, which may be a ground cage receptacle, that may include rigid insulation, may be used. In addition, the ground cage receptacle 158 may guide a connection between the lead frame connector 102A, 102B and a receiving connector, such as described with respect to at least FIG. 2A. In one example, a short ground cage receptacle 158 may support a connection between a lead frame connector 102A, 102B and a daughter board. The short ground cage receptacle 158 may include a daughter board connector pair 160A of pins. The long ground cage receptacle 158 (relative to the short ground cage receptacle) may support a connection between a lead frame connector 102A, 102B and a backplane or a midplane. The long ground cage receptacle 158 may include a midplane or backplane connector pair 160B of pins. The connector 104, in one example, is between a daughter board and a backplane or a midplane, which is detailed further with respect to at least FIG. 2A.

FIG. 1II is an excerpt view 100II of a connector having retracted pins in its barrel sections, in accordance with at least some embodiments. FIG. 1II illustrates that, when coupled against a circuit board or a computing component, the pins 110 may be in a retracted pin 110B position within the barrel section 108 of each barrel pair 156. FIG. 1II illustrates that the lead pair 154 and the barrel pair 156 may include air as insulation or a rigid insulation therebetween. In one example, the ground cage receptacles 158 may support a distance maintained between the connectors 104 in each of the lead pair 154 and the barrel pair 156. FIG. 1II also illustrates that there may be multiple of ones of the lead pair 154 and the barrel pair 156, based in part on the type of lead frame connector 102A, 102B. For example, the lead frame connector may communicate signals for different standards referenced throughout herein or may communicate power, as described in connection with at least FIGS. 4 and 5, in one example.

FIG. 1II also illustrates that, when a frame connector 102A, 102B of a daughter board is coupled to a receiving connector (such as in FIGS. 2A, 2B) of a midplane or a backplane 202 (also in FIGS. 2A, 2B), the pins 110 of the connectors 104 pass through the receiving connector and contact 162 surface contact pads 220 of the midplane or the backplane 202. The contact 162 includes a predetermined pressure 164 between the pins 110 and the surface contact pads 220 that may be sufficient to cause the retracted pin 110B position for each of the pins 110. The pressure 164 is also sufficient to ensure that the retracted pins 110B maintain electrical connectivity by the contact 162 so as to pass signals from the midplane or the backplane 202 and through each connector 104 of the lead frame connector 102A, 102B.

The contact 162 avoids problems of the compliant interfaces which anchor into a PCB. The retracted pins 110B allow coupling and decoupling without through-hole or compression pins to mate to surface contact pads. In each case, the pins 110 capable of being in a retracted pin 110B position allow predetermined insertion or compression forces without damage or loss of contact after repeated coupling and decoupling using the lead frame connector 102A, 102B herein. In addition, the pins 110 capable of being in a retracted pin 110B position allow constant force, as part of the pressure 164, so that the pins 110 remain in contact with the surface contact pads 220. The lead frame connector 102A, 102B herein ensures that there need not be additional interfaces between each connector 104 and a circuit board, such as the midplane or the backplane 202.

FIG. 1JJ illustrates a cross-sectional excerpt view 100JJ of a connector having retracted pins and compressed springs in its barrel sections, in accordance with at least some embodiments. In one example, FIG. 1JJ illustrates a cross-section of the excerpt view 100FF from FIG. 1II. FIG. 1JJ illustrates that, when coupled against a circuit board or a computing component, the pins 110 may be in a retracted pin 110B position within the barrel section 108 of each barrel pair 156 at least by a compression to a respective spring 112 so that the spring 112 is in a compressed spring 112A position.

FIG. 2A illustrates a connection 200A between two circuit boards and used for differential signaling by a lead frame connector, in accordance with at least some embodiments. One of the circuit boards may be a midplane or a backplane 202 and another one of the circuit boards may be a daughter board 204. The lead frame connector 102A, 102B may include a rigid form factor 206 provided by at least rigid insulation that may be all throughout the lead sections 106 and one or more of the barrel sections 108 of individual connectors 104. As illustrated, the lead frame connector 102A, 102B may be held down by ground cage receptacles 158 of individual daughter board connector pairs 160A and of individual midplane or backplane connector pairs 160B. In another example, an external tie or other external retainers 208 may be used between the circuit boards and the lead frame connector 102A, 102B. The external tie or other external retainers 208 may function to retain or restrict the lead frame connector 102A, 102B from disconnection or movement away from a receiving connector 210 of a circuit board. On at least the daughter board 204, the receiving connector may be the surface contact pads and the external tie or other external retainers 208, in one example. On the midplane or the backplane, the surface contact pads 220 may be aligned with the receiving connector 210 and its associated ground cage receptacles 158 to allow a connection from a lead frame connector 102A, 102B. The pins 110 on the lead frame connector 102A, 102B are pressed, such as pressured or forced, against the surface contact pads 220s at least by a bias from the springs 112.

FIG. 2B illustrates a connection 200B between a daughter board and a backplane or a midplane and other computing components, in accordance with at least some embodiments. FIG. 2B illustrates the use of a right-angled lead frame connector 262 between a daughter board 204 and a midplane or backplane 202. The right-angled lead frame connector 262 may be as described in connection with FIG. 2A, and specifically, as to the lead frame connector 102A, 102B in FIG. 2A. FIG. 2B also illustrates the use of a straight-through lead frame connector 264 having a straight lead section 106 and a straight barrel section 108 for each of its connectors 104. The straight-through lead frame connector 264 may be provided between computing components 266 and the daughter board 204. The computing components may be adapters, memory sticks, communication cards, and others that may be intended for use with a daughter board 204 or the midplane or backplane 202, through the daughter board 204. The straight-through lead frame connector 264 need not include the angled feature 118 in its individual connectors 104, in one example.

Each of the right-angled lead frame connector 262 and the straight-through lead frame connector 264 may include integration of the spring-loaded pins 110 as part of its lead frame connector's internal structure with a lead section 106 and with a barrel section 108 which is formed from a portion of the lead section, as discussed in detail with one or more of FIGS. 1AA-1JJ. In at least one example, the pin 110 in each connector 104 of the right-angled lead frame connector 262 and the straight-through lead frame connector 264 may extend from or retract into the barrel section 108 based in part on an interface 128 with the spring 112. The pin 110 is to contact a surface contact pad on a circuit board (that is either the daughter board 204 or the midplane or backplane 202, depending on the connection made). The contact may be used to pass signals from the circuit board through the connector. In addition, each connector 104 may include a first barrel section to couple, through a lead section, to a second barrel section. Each conductor may be part of a conductor array of a lead frame connector and may be such that the first barrel section is coupled to a daughter board 204 and the second barrel section is coupled to a midplane or a backplane 202 of a rack in a datacenter, which is detailed further in at least FIG. 5.

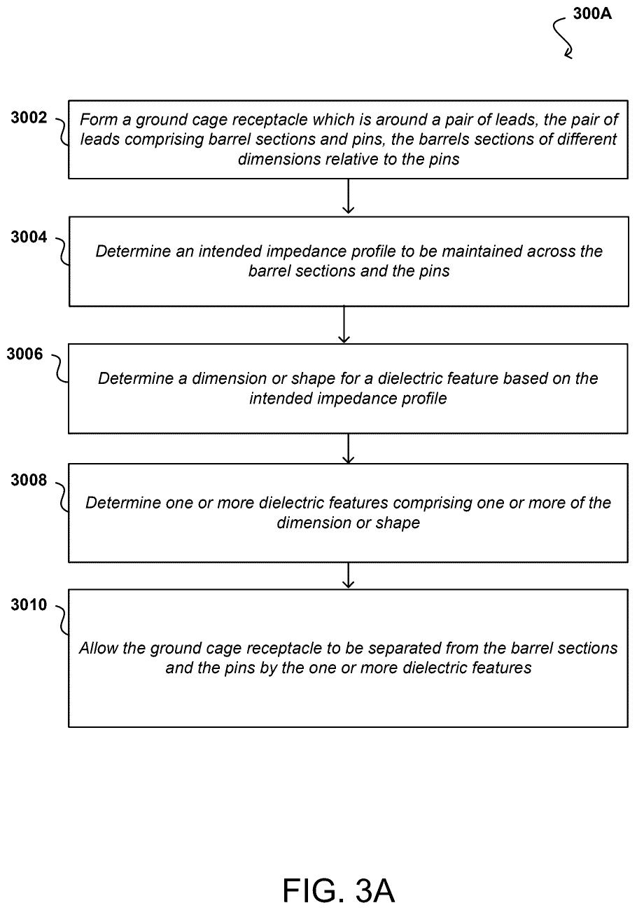

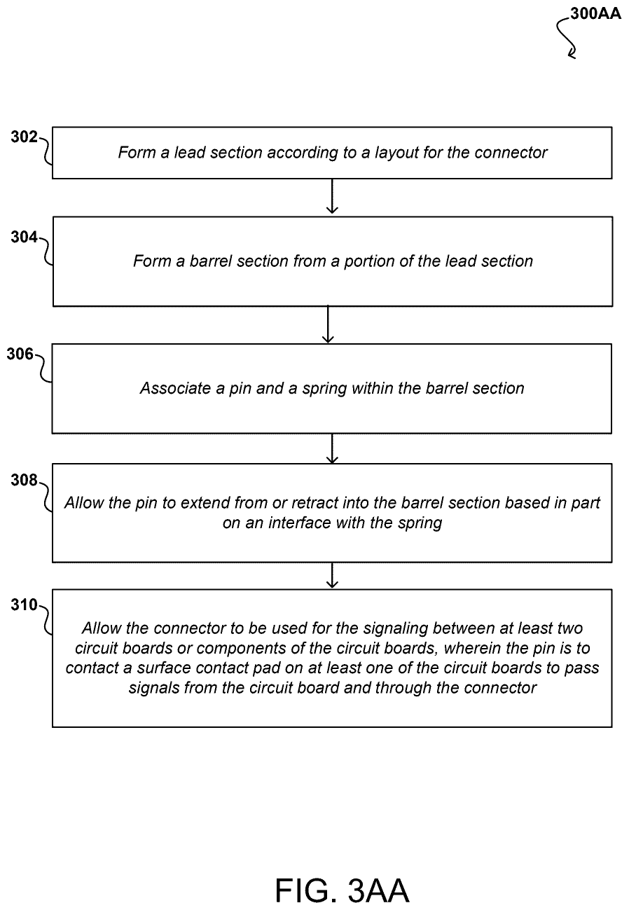

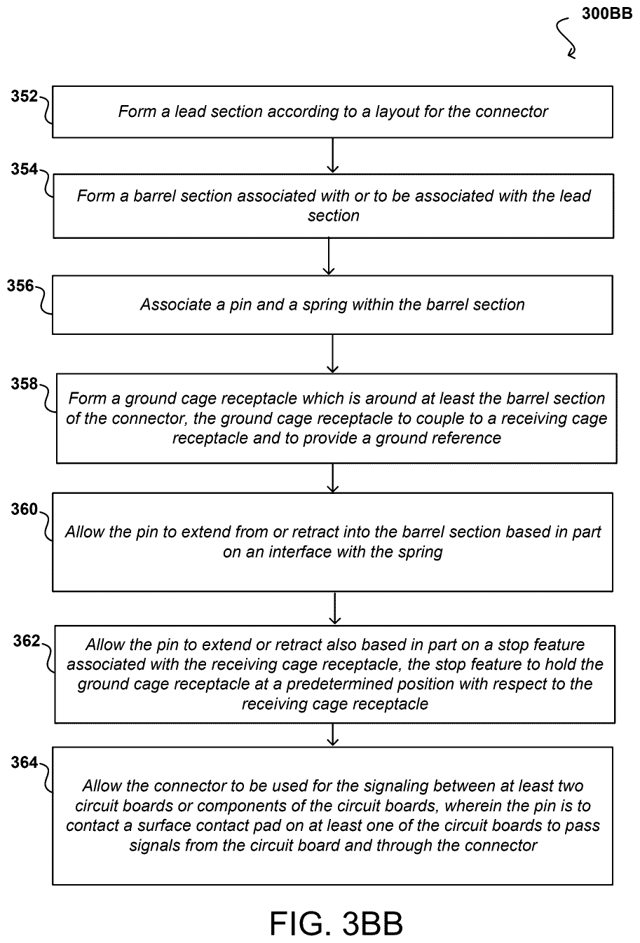

FIG. 3A illustrates a process or method 300A for a circuit board connector having a ground cage receptacle which is separated, by one or more dielectric structures, from barrel sections and pins of a pair of leads therein, in accordance with at least some embodiments. The method 300A may be used with any of the methods 300AA, 300BB in FIGS. 3AA and 3BB herein. The method 300A may include a step to form 3002 a ground cage receptacle which is around a pair of leads. The pair of leads may include barrel sections and pins. The barrel sections may be of different dimensions relative to the pins. The method 300A may include a step to determine 3004 an intended impedance profile to be maintained across the barrel sections and the pins. The method 300A may include a step to determine 3006 a dimension or shape for a dielectric structure based on the intended impedance profile.

The method 300A may include a step to determine 3008 one or more dielectric structures comprising one or more of the dimensions or shapes. In some examples, the one or more of the dimensions or shapes for a dielectric structure may be predetermined based at least in part on an intended impedance profile, as in FIGS. 1F-1H, to be maintained across the barrel sections and the pins. There may be a datastore to retain the intended impedance profile for difference profiles. The intended impedance profile may be a reference for the dielectric structure to be used with a circuit board connector based on the application, for instance. The method 300A may include a step to allow 3010 the ground cage receptacle to be separated from the barrel sections and the pins by the one or more dielectric structures.

The method 300A may include a step or sub-step for determining individual spacers having individual predetermined dimensions based in part on the intended impedance profile to be maintained across the barrel sections and the pins. The method 300A may include a step or sub-step for allowing the one or more dielectric structures to include the individual spacers with predetermined spacing therebetween. The predetermined spacing may be also based in part on the intended impedance profile to be maintained across the barrel sections and the pins.

The method 300A may include a step or sub-step for allowing the individual spacers to include a first spacer located in a distal position with respect to a first end of the pair of leads. The individual spacers may include a second spacer located in a proximal position with respect to a second end of the pair of leads. The individual spacers may include a third spacer located in a middle position with respect to the first end and the second end of the pair of leads. The method 300A may include a step or sub-step for allowing the individual spacers to include one of different predetermined thicknesses as part of the dimension or shape. The individual ones of the different predetermined thicknesses may be associated with different impedance profiles available to be maintained across the barrel sections and the pins.

The method 300A may include a step or sub-step for determining an axial element to extend substantially along a length which includes the barrel sections and the pins. The method 300A may include a step or sub-step for allowing the one or more dielectric structures to comprise the axial element with distributed spacers. The method 300A may include a step or sub-step for preparing the distributed spacers to include a same predetermined spacing therebetween which is based in part on the intended impedance profile to be maintained across the barrel sections and the pins.

The method 300A may include a step or sub-step for determining axial elements with distributed spacers for the circuit board connector. The method 300A may include a step or sub-step for allowing individual ones of the axial elements to be at individual corners of the ground cage receptacle. The method 300A may include a step or sub-step for allowing the individual ones of the axial elements to extend substantially along a length which includes the barrel sections and the pins or allowing the individual ones of the plurality of axial elements to extend laterally across the length of the ground cage receptacle.

The method 300A may include a step or sub-step for allowing the one or more dielectric structures to be resiliently moved or deformed when the connector is associated with a receiving connector of a circuit board. The method 300A may include a step or sub-step for allowing the one or more dielectric structures to include discontinuous edges along a boundary which is within the ground cage receptacle. The one or more dielectric structures may be allowed to include at least one air gap within the one or more dielectric structures and between the pair of leads.

The method 300A may include a step or sub-step for allowing the circuit board connector to be part of an array of connectors forming a lead frame connector between a first circuit board and a second circuit board or computing component. The method 300A may include a step or sub-step for predetermining the dimension or shape to allow or support a less than one percent deviation in a practical application of an impedance profile, with respect to the intended impedance profile.

FIG. 3AA illustrates a process or method 300AA for a connector having a lead section and a barrel section, in accordance with at least some embodiments. For instance, the method 300AA may include a step to form 302 a lead section according to a layout for the connector. The layout may be provided during design of the circuit boards, in one example. The layout may be provided during design of a rack, in another example. The layout may include distances and spaces available to the one or more circuit boards for coupling together and for use with cables or other computing devices, in one example. The method 300AA may include a step to form 304 a barrel section from a portion of the lead section. The method 300AA may include a step to associate 306 a pin and a spring within the barrel section. The method 300AA may include a step to allow 308 the pin to extend from or retract into the barrel section based in part on an interface with the spring. The method 300AA may include a step to allow 310 the connector to be used for the signaling between at least two circuit boards or components of the circuit boards. The pin may be to contact a surface contact pad on at least one of the circuit boards to pass signals from the circuit board and through the connector. In another example, the step to allow 310 the connector to be used may include usage in power connections between a source and to the circuit board.

FIG. 3BB illustrates a process or method 300BB for a connector having ground cage receptacles, in accordance with at least some embodiments. The method 300BB in FIG. 3BB may be used with the method 300AA in FIG. 3AA. The method 300BB may provide a connector for signaling. The method 300BB may include a step to form 352 a lead section according to a layout for the connector. The method 300BB may include a step to form 354 a barrel section which is associated with or to be associated with the lead section. The method 300BB may include a step to associate 356 a pin and a spring within the barrel section. The method 300BB may include a step to form 358 a ground cage receptacle which is around at least the barrel section of the connector. The ground cage receptacle may be formed to couple to a receiving cage receptacle and to provide a ground reference. The method 300B may include a step to allow 360 the pin to extend from or retract into the barrel section based in part on an interface with the spring. The method 300BB may include a step to also allow 362 the pin to extend and retract based in part on a stop feature associated with the receiving cage receptacle. The stop feature may hold the ground cage receptacle at a predetermined position with respect to the receiving cage receptacle. The method 300BB may include a step to allow 364 the connector to be used for the signaling between at least two circuit boards or components of the circuit boards. As part of the method 300BB, the pin may contact a surface contact pad on at least one of the circuit boards to pass signals between the circuit boards and through the connector.

The method 300BB may include a step or sub-step to form the ground cage receptacle to fit over the receiving connector. The method 300BB may include a step or sub-step to form the stop feature as part of an external insulation that is around the receiving cage receptacle or as part of an internal insulation within the receiving cage receptacle. The method 300BB may include a step or sub-step to determine a contact application comprising a predetermined pressure or contact resistance between the pin and the signal surface contact pad. The method 300BB may include a step or sub-step to allow the contact between the pin and the signal surface contact pad based in part on the contact application.

The method 300BB may include a step or sub-step to allow the connector to be part of a daughter board. The method 300BB may include a step or sub-step to allow the receiving connector to be part of a backplane or midplane. The method 300BB may include a step or sub-step to solder or affix the receiving cage receptacle to ground surface contact pads, channels, or lines on the backplane or midplane. The signal surface contact pads may be within a perimeter formed by the ground surface contact pads, channels, or lines. The method 300BB may include a step or sub-step to allow, using the connector, a differential signal connection with the ground reference. A data signal of the pin may be one of a set of differential signals. The pin itself may be one of a set of differential signal pins supported by the ground reference from the ground cage receptacle.

FIG. 4 illustrates an example datacenter to apply at least one embodiment for power connection in FIGS. 1A-3BB and 5-7. The datacenter 400 may include racks 404 that may be associated with servers 406 therein (in a server tray, server box, or server/computer module format), and that may include compute devices therein to perform a workload. Although illustrated as horizontal features, the servers 406 may be vertically provided within a rack 404. Such racks 404 may be tied (such as hardwired or natively within rows of racks) as part of the infrastructure of the datacenter 400. For instance, the racks 404 may be associated with power supply units (PSUs) and may be associated with a busbay 416 to receive and distribute power for the servers 406, these racks 404 may necessarily include power components (such as busbars 418) that are intimately associated with the racks 404. The power components may be part of the infrastructure of the datacenter 400. The racks 404 may include high-speed interconnect, enabling high-speed communication between subsystems, including the servers 406.

The compute devices may be provided on circuit boards and may include processors (such as central processing units (CPUs), quantum processing units (QPUs), graphics processing units (GPUs), data processing units (DPUs), application-specific integrated circuits (ASICs), field-programmable gate arrays (FPGAs), physics processing units (PPUs), or the like), and other components (such as memory, communication modules, input/output modules, and the like).

In at least one embodiment, the datacenter 400 may include one or more rooms 402 of racks 404, where the racks 404 may include server trays or servers 406. The datacenter 400 may be powered from a power distribution 408 system, via one or more transformers 410 (Tr.), so that the power to a switchgear 412 may be suitable for the datacenter. For instance, the power distribution 408 system may be part of a transmission system. The transmission system may provide high-voltage electricity from a utility grid. Each transformer 410 may step down the voltage to a level suitable for the datacenter's equipment and devices, such as the aforementioned processors that may be in the server trays or servers 406 in each rack 404. The switchgear 412 may be able to control, protect, and isolate power in both downstream and upstream directions.

The switchgear 412 may be used to manage flow of electricity in a reliable and efficient manner using switching of electrical circuits for controls and using breakers and fuses to detect and respond to faults or overloads in both downstream and upstream directions. In addition to an external source represented by the transmission systems and to ensure uninterrupted power supply, a backup 414 system, such as a generator or Uninterruptible Power Supply (UPS), may be used with the power distribution 408 system (Power Dist.). In addition, a cooling unit 426 may provide at least air cooling for the cold aisle 430 side and pass through the racks 404 to the hot aisle 428 side of the datacenter 400. The movement of the air cooling may be supported by fans, in one example.

The switchgear 412 may be associated with the busbay 416. The busbay 416 may provide power to one or more racks 404. In one example, the busbay 416 may provide power to one or more racks 404 through provided busbars 418. The busbars 418 may be conductive bars that carry electrical current to various loads, including those represented by the aforementioned processors, which may be within the server trays or computer modules (also referenced as servers 406) in each rack 404 of the datacenter 400. The busbars 418 may be provided from copper, aluminum, or a suitable power delivery material. The busbars 418 may be able to work together to handle the high-current demands of the datacenter 400.

The datacenter 400 may include a midplane or a backplane 202, as in FIGS. 2A, 2B, and the related discussions. The midplane or the backplane 202 may have the surface contact pads to receive the lead frame connectors 102A, 102B, 262, 264 (such as in FIGS. 1DD and 2B) from other circuit boards (such as the daughter boards 204 in FIGS. 2A and 2B) or from other components of the datacenter. These components may include power components as described herein and the computing components 266, as described in connection with FIG. 2B, for instance. The midplane or the backplane 202 may be associated with receiving connectors 210 to receive lead frame connectors of the daughter boards 204, where multiple daughter boards 204 may be plugged into the midplane or backplane 202. The lead frame connectors may include individual connectors 104 with pins 110 and springs 112. The pins 110 may be to contact surface contact pads within the receiving connectors using the pins. The pins 110 and the surface contact pads may include a robust connection therebetween based in part on a spring bias from the springs 112 of the lead frame connectors on the surface contact pads of the receiving connectors and based in part on an alignment supported by the ground cage receptacles 158 and any rigid insulation 150 provided as part of the lead frame connectors 102A, 102B.

FIG. 5 illustrates aspects 500 of an example rack to apply at least one embodiment in FIGS. 1A-4 and 6A-7. The aspects 500 illustrate that a rack 404 may have at least one circuit board that may be a midplane or a backplane 202. Although illustrated as open, the rack 404 may be fully enclosed with front, back, side, and top covers or access panels. Also, although illustrated at a high-level flat structure, the circuit board may include at least one PCB (also, as illustrated and described in at least FIGS. 2A and 2B). When used as a backplane, a circuit board may include a single side of receiving connectors 506 to receive lead frame connectors 504 of the daughter boards or cards 204. When used as a midplane, the circuit board may include two sides of receiving connectors 506 to receive lead frame connectors 504 of the daughter boards or cards 204 on both sides of the circuit board. In the aspects 500 in FIG. 5, the circuit board is a midplane which is located at a middle of a rack 404. The midplane may receive servers 406 in a vertical board format or daughter boards 204, which may be pushed for insertion 502 against the receiving connectors 506, for instance, of the midplane forming one or many connections between the midplane and the servers or the daughter boards 204.

FIG. 5, along with FIGS. 1A-1CC also illustrate aspects 500 of a datacenter having a midplane or a backplane 202, one or more daughter boards 204, multiple connectors 104 arranged in an array (in FIGS. 1GG and 2A), and ground cage receptacles within the connectors (as in FIGS. 1AA-1CC). The midplane or a backplane 202 may include signal surface contact pads for differential signals and ground surface contact pads, channels, or lines. The midplane or a backplane 202 may include receiving connectors 506 individually associated with the ground surface contact pads, channels, or lines.

The one or more daughter boards 204 may be coupled to the midplane or backplane 202 through a lead frame connector 504. The lead frame connectors 504 may include the connectors arranged in an array and may include ground cage receptacles within the connectors. The ground cage receptacles may be around barrel sections having pins and springs, of the lead frame connectors 504. Individual ones of the ground cage receptacles may be around individual pairs of the barrel sections. The ground cage receptacle may couple to the receiving cage receptacles to provide ground references for data signals through the pins and the springs. The pins may extend from or retract into respective ones of the barrel sections, based at least in part on a respective stop feature associated with respective ones of the receiving cage receptacles. The respective stop features may hold the ground cage receptacles at a predetermined position with respect to the receiving cage receptacles. The respective stop features may allow the pins to contact the signal surface contact pads for transmission of the data signals between the one or more daughter boards and the midplane or the backplane.

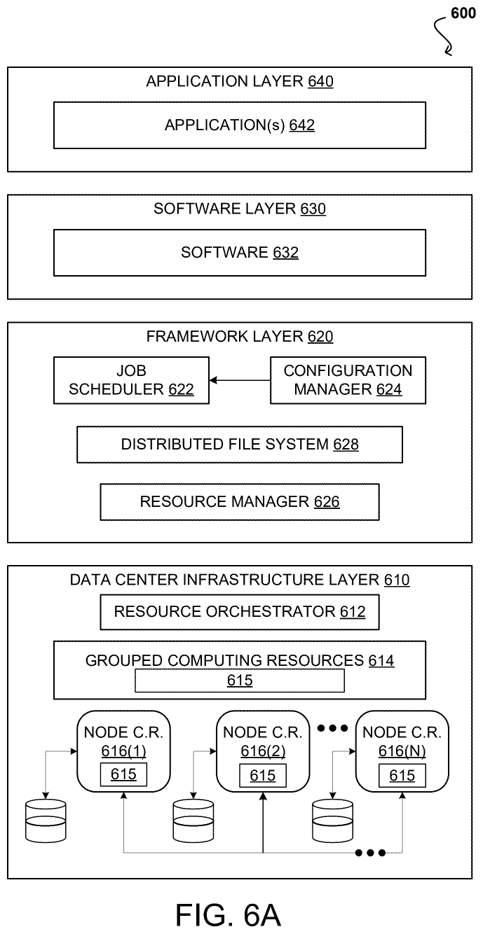

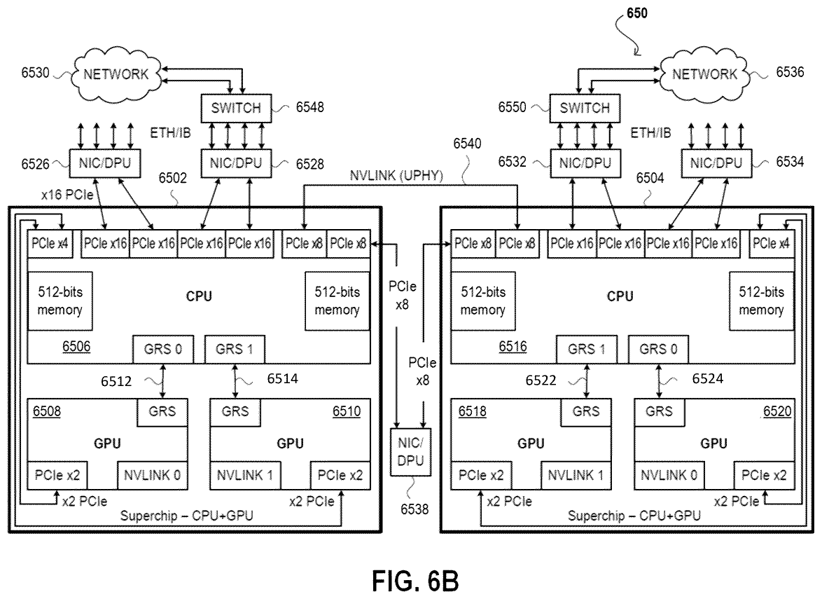

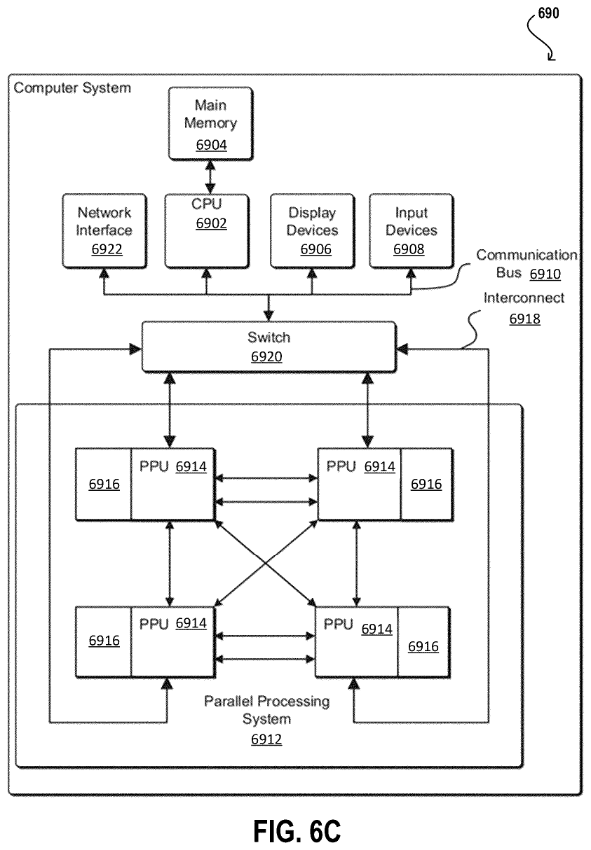

FIG. 6A illustrates an example datacenter 600, in which at least one embodiment may be used. In at least one embodiment, datacenter 600 includes a datacenter infrastructure layer 610, a framework layer 620, a software layer 630, and an application layer 640. FIG. 6A illustrates an example datacenter 600, in which at least one embodiment may be used. In at least one embodiment, datacenter 600 includes a datacenter infrastructure layer 610, a framework layer 620, a software layer 630, and an application layer 640. A datacenter 600 may include one or more racks, such as described in connection with at least FIGS. 1DD and 1EE. The racks may include one or more server trays. There may be one or more electronic components in the one or more server trays to perform at least part of a workload in the datacenter. The racks and server trays may be represented by at least the datacenter infrastructure layer 610. The electronic components may be presented by the node computing resources 616(1)-616(N) that may be subject to cooling using cold plates.

The datacenter 600 may include a cooling loop to remove heat from the electronic components during performance of the workload. The cooling loop may include a manifold with manifold modules and a lid as detailed in one or more of FIGS. 2A to 5D The lid may include a curved surface to be positioned within a passage of the manifold. The curved surface may be configured to receive and direct a flow of a cooling fluid away from a stagnant flow space within the manifold. The datacenter 600 may include multiple segment cooling loops to remove heat from the electronic components during performance of the workload. The segment cooling loops may include multiple manifold modules. Individual outlets of the manifold modules can direct a cooling fluid. Multiple lids at different ends of the plurality of manifold modules can reduce a flow velocity of the cooling fluid, by a predetermined threshold, at the individual outlets.

In at least one embodiment, as shown in FIG. 6A, datacenter infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in datacenters at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for datacenter 600. In at least one embodiment, resource orchestrator may include hardware, software or some combination thereof.

In at least one embodiment, as shown in FIG. 6A, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may use distributed file system 628 for large-scale data processing (e.g., “big data”). In at least one embodiment, job scheduler 622 may include a Spark driver to facilitate scheduling of workloads supported by various layers of datacenter 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at datacenter infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. The one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a datacenter operator of datacenter 600 from making possibly bad configuration decisions and possibly avoiding underused and/or poor performing portions of a datacenter.

In at least one embodiment, datacenter 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 600. In at least one embodiment, trained machine learning models corresponding to one or more neural networks may be used to infer or predict information using resources described above with respect to datacenter 600 by using weight parameters calculated through one or more training techniques described herein.

In at least one embodiment, datacenter may use CPUs, application-specific integrated circuits (ASICs), GPUs, FPGAs, DPUs, QPUs or PPUs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 6A for inferencing or predicting operations based, at least in part, on weight parameters calculated using neural network training operations, neural network functions and/or architectures, or neural network use cases described herein.

FIG. 6B is a block diagram that schematically illustrates a computing system that may be a datacenter or a High-Performance Computing (HPC) cluster, in which at least one embodiment from FIGS. 1A-5 may be used. The computing system 650 may include a plurality of subsystems, e.g., multiple processing devices coupled to each other, multiple network devices, and multiple networks, according to at least some embodiments. The computing system 650 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 650 and to one or more external networks 6530, 6536. In the present example, computing system 650 comprises a packet switch 6548 that connects NIC/DPU 6528 to external network 6530, and a packet switch 6550 that connects NIC/DPU 6532 to external network 6536.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 650 can include one or more CPUs and one or more GPUs.

FIG. 6B also demonstrates an example architecture of a multi-GPU architecture. As illustrated in the figure, computing system 650 includes a processing device 6502 with a multi-GPU architecture. In particular, processing device 6502 may be a system-on-chip and includes multiple subsystems such as a CPU 6506, a GPU 6508, and a GPU 6510. CPU 6506 can be coupled to GPU 6508 via a die-to-die (D2D) or chip-to-chip (C2C) interconnect 6512, such as a Ground-Referenced Signaling interconnect (GRS interconnect). CPU 6506 can be coupled to GPU 6510 via a D2D or C2C interconnect 6514. CPU 6506 can also couple to GPU 6508 and GPU 6510 via PCIe interconnects.

CPU 6506 can be coupled to one or more NICs or DPUs, which are coupled to one or more networks. For example, as illustrated in FIG. 6B, CPU 6506 is coupled to a first NIC/DPU 6526, which is coupled to an external network 6530. CPU 6506 is also coupled to a second NIC/DPU 6528, which is coupled to external network 6530 via packet switch 6548. NIC/DPU 6526 and NIC/DPU 6528 can be coupled to external network 6530 over Ethernet (ETH), NVLINK or InfiniBand (IB) connections, for example.

Computing system 650 also includes a processing device 6504 with a multi-GPU architecture. In particular, processing device 6504 includes multiple subsystems including a CPU 6516, a GPU 6518, and a GPU 6520. CPU 6516 can be coupled to GPU 6518 via a D2D or C2C interconnect 6522. CPU 6516 can be coupled to GPU 6520 via a D2D or C2C interconnect 6524. CPU 6516 can also couple to GPU 6518 and GPU 6520 via PCIe interconnects. CPU 6516 can be coupled to one or more NICs or DPUs, which are coupled to one or more networks. For example, as illustrated in FIG. 6B, CPU 6516 is coupled to a first NIC/DPU 6532, which is coupled to an external network 6536. CPU 6516 is also coupled to a second NIC/DPU 6534, which is coupled to the external network 6536 via packet switch 6550. NIC/DPU 6532 and NIC/DPU 6534 can be coupled to the external network 6536 over Ethernet (ETH), NVLINK or InfiniBand (IB) connections.

In at least one embodiment, processing device 6502 and processing device 6504 can communicate with each other via a NIC/DPU 6538, such as over PCIe interconnects. Processing device 6502 and processing device 6504 can also communicate with each other over a high-bandwidth communication interconnects 6540, such as an NVLink interconnect or other high-speed interconnects. The packet switches in FIG. 6B may comprise, for example, Nvidia Quantum-2 switches. The NICs/DPUs in the figure may comprise, for example, Nvidia Bluefield DPUs.

In various embodiments, any of the network devices of the computing system 650, e.g., any of NICs/DPUs 6526, 6528, 6532, 6534 and 6538, and/or any of packet switches 6548 and 6550, may include a shaped leak sensor that can match a geometry around components and features in the computing system 650 and that can be communicatively coupled together to extend leak detection capabilities.

FIG. 6C illustrates a computer system, according to at least one example, in which at least one embodiment from FIGS. 1A-6B and 7 may be used. In at least one embodiment, computer system 690 is configured to implement various processes and methods described throughout this disclosure.

In at least one embodiment, computer system 690 comprises, without limitation, at least one central processing unit (“CPU”) 6902 that is connected to a communication bus 6910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 690 includes, without limitation, a main memory 6904 and control logic (e.g., implemented as hardware, software, or a combination thereof) and data are stored in main memory 6904 which may take form of random access memory (“RAM”). In at least one embodiment, a network interface subsystem (“network interface”) 6922 provides an interface to other computing devices and networks for receiving data from and transmitting data to other systems from computer system 690.

In at least one embodiment, computer system 690, in at least one embodiment, includes, without limitation, input devices 6908, parallel processing system 6912, and display devices 6906 which can be implemented using a conventional cathode ray tube (“CRT”), liquid crystal display (“LCD”), light emitting diode (“LED”), plasma display, or other suitable display technologies. In at least one embodiment, user input is received from input devices 6908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 6904 and/or secondary storage. Computer programs, if executed by one or more processors, enable computer system 690 to perform various functions in accordance with at least some embodiments. Main memory 6904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 6902; parallel processing system 6912; an integrated circuit capable of at least a portion of capabilities of both CPU 6902; parallel processing system 6912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 690 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 6912 includes, without limitation, a plurality of parallel processing units (“PPUs”) 6914 and associated memories 6916. In at least one embodiment, PPUs 6914 are connected to a host processor or other peripheral devices via an interconnect 6918 and a switch 6920 or multiplexer. In at least one embodiment, parallel processing system 6912 distributes computational tasks across PPUs 6914 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 6914, although such shared memory may incur performance penalties relative to use of local memory and registers resident to a PPU 6914. In at least one embodiment, operation of PPUs 6914 is synchronized through use of a command such as_syncthreads( ), wherein all threads in a block (e.g., executed across multiple PPUs 6914) to reach a certain point of execution of code before proceeding.

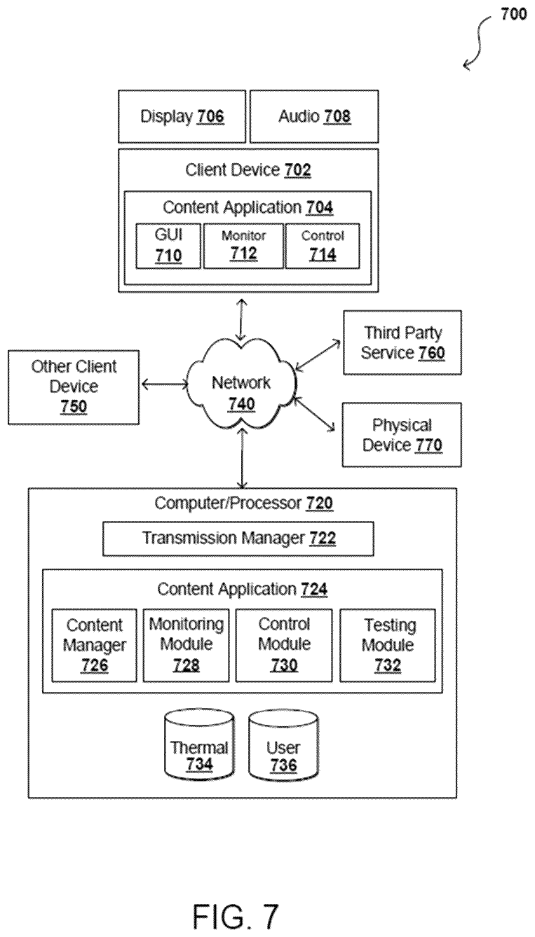

FIG. 7 illustrates an example network configuration 700 of components that can be used to implement aspects of various embodiments, such as to provide, generate, modify, encode, process, fuse, and/or transmit generated image data, calculated measurements, or other such content. In at least one embodiment, a client device 702 can generate or receive data for a session using components of a content application 704 on the client device 702 and data stored locally on that client device. In at least one embodiment, a content application 724 executing on a computer or processor 720 (e.g., a cloud server or control system) may initiate a session associated with at least one client device 702 (e.g., a vehicle or robot), as may use a session manager and user data stored in a user database 736, and can cause content such as liquid coolant or server thermal data to be selected and/or retrieved from a thermal repository 734 to be used by a testing module 732 to calculate one or more performance metrics for a monitoring module 728, which can provide flow data or thermal data to a control module 730 to control a flow or temperature, in an environment where the data is to be used to determine appropriate operation. A content manager 726 may work with these various modules to perform testing and analysis, and potentially instruct any actions to be taken in response to a performance metric failing to satisfy an operational requirement. At least a portion of this data or instructional content can be transmitted to the client device 702 and/or a physical device 770 using an appropriate transmission manager 722 to send by download, streaming, or another such transmission channel. An encoder may be used to encode and/or compress at least some of this data before transmitting to the client device 702. In at least one embodiment, the client device 702 receiving such content can provide this content to a corresponding content application 704, which may also or alternatively include a graphical user interface (GUI) 710, a flow monitor module 712, and a control module 714 for use in providing, synthesizing, rendering, compositing, modifying, or using content for presentation, navigation, control, (or other purposes) on or by the client device 702, such as may be transmitted to the physical device 770. In some embodiments, the computer/processor 720 and client device 702 may be able to communicate directly without needing to transmit data over a network 740, in order to avoid issues with latency and availability, etc. A decoder may also be used to decode data received over the network 740 for presentation via client device 702, such as imaging content or performance metrics through a display device 706 and audio, such as corresponding sounds or synthesized speech, through at least one audio playback device 708, such as speakers or headphones. In at least one embodiment, at least some of this content may already be stored on, rendered on, or accessible to client device 702 such that transmission over a network 740 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer/processor 720, or user database 736, to the client device 702. In at least one embodiment, at least a portion of this content can be obtained, enhanced, and/or streamed from another source, such as a third party service 760 or other client device 750, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit).

In at least one embodiment, a cold plate herein may include adjustable fins forming microchannels for fluid to flow through. In at least one embodiment, fins in a cold plate allow transfer of heat from at least one associated computing device to a fluid flowing through microchannels formed between multiple fins. In at least one embodiment, fins of a cold plate are dynamically and adjustable in real time to allow transfer of more heat from at least one computing device to a fluid that flows through a cold plate having fins. In at least one embodiment, such fins may be adjusted by a processor or processorless system based in part on a temperature determined, such as sensed, for a cold plate. In at least one embodiment, a temperature may be associated with at least one computing device, a workload of at least one computing device, or a fluid at different time periods and at an entry, and at an egress of a cold plate. In at least one embodiment, a processorless system may rely on a thermal property of at least two materials used to form fins for a cold plate so that such fins may react without a processor to cause exposure of more surface area to a fluid. In at least one embodiment, such fins may include an overlapping portion that may be caused to be exposed by an action of a control mechanism or by properties of at least two materials associated together to form a fin.

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a datacenter or server farm. In at least one embodiment, the request may be received or processed by at least one edge server, which sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for monitoring or managing thermal conditions of a server which includes cold plates as liquid manifolds. In other embodiments, such a system can be used for other purposes, such as for providing control of liquid coolant flow, or for performing deep learning operations. In at least one embodiment, such a system can be implemented using an edge device or may incorporate one or more Virtual Machines (VMs). In at least one embodiment, such a system can be implemented at least partially in a datacenter or at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

The medium of transmission is any type of networking cable e.g., direct attach copper (DAC), active copper cable (ACC), active optical cables (AOCs), cable assembly with OSFP connectors or the like) or interconnect utilized by datacenter racks and associated switch modules (e.g., a Small Form Pluggable (SFP), quad small form-factor pluggable (QSFP), or the like). It may also be a passive copper cable (PCC), an active optical cable and an active optical module for transmitting optical signals. In other alternative cases, the cable may also include an Ethernet cable, active optical cables (AOCs) or cable assembly with OSFP connectors. The semiconductor device may be a pluggable network interface device may comprise the male end portion of a direct attach cable assembly (DAC). The network connectors may each be configured to connect to a networking device of any type (e.g., QSFP, Direct Attach Copper, active optical cables (AOC), etc.), and may thus be dimensioned (e.g., sized and shaped) to mate with or otherwise connect to any corresponding networking device. The cable connector may be of any type (e.g., an AOC connector, Ethernet connector, Direct Attach Copper connector, Active Optical Module, or the like). A PCB is used to electrically connect electronic components using conductive pathways, or traces, etched from metal sheets. In many electronic systems, one or more very large-scale integrated circuit (“VLSI”) components is coupled to a host system printed circuit board (“PCB”). Such VLSI components may include, for example, central processing unit (“CPU) devices and graphics processing unit (“GPU”) devices. The PCB may hold at least one processing circuitry. The processing circuitry may comprise hardware, such as an application specific integrated circuit (ASIC). The processing circuitry may comprise an ASIC and/or may be capable of performing as a central processing unit (CPU), a graphics processing unit (GPU), a network interface controller (NIC), a data processing unit (DPU), or any other computing device in which with data is received and/or transmitted. Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. It should be appreciated that any appropriate type of electrical or optical component or collection of electrical or optical components may be suitable for inclusion in the processing circuitry. Numerous example embodiments will be described below in which a semiconductor package is mounted within a through hole of a PCB. Although PCBs having certain types and form factors appear in the drawings and the discussion, it should be noted that the illustrated and described types and form factors are provided by way of example only. Persons having skill in the art and having reference to this disclosure will readily appreciate that the same or similar apparatus and techniques may also be employed with PCBs having other types and form factors. For example, in some embodiments, the PCB to which the semiconductor package is mounted may comprise an add-in card, such as a PCIe card, that is configured to be coupled to a system board or motherboard of a host system. In other embodiments, the PCB to which the semiconductor package is mounted may be the system board or motherboard of the host system itself. Moreover, the system board or the motherboard may be associated with any type of host system. For example, the PCB may comprise the system board in a multi-node rack-mounted server in a data center, or it may comprise the motherboard of a workstation, desktop, laptop, or mobile device. Other embodiments are also possible.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU, GPU, DPUs, QPUs, or PPUs. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

Additional clauses are also provided below.

### Clause 1

A circuit board connector comprising a ground cage receptacle which is around a pair of leads, the pair of leads comprising barrel sections and pins, the barrel sections of different dimensions relative to the pins, wherein the ground cage receptacle is separated from the barrel sections and the pins by one or more dielectric structures, and wherein the one or more dielectric structures comprise one or more of a dimension or shape which is predetermined based at least in part on an intended impedance profile to be maintained across the barrel sections and the pins. In some examples, the impedance profile may include impedance values in the range of about 82 to about 100 Ohms of differential impedance. In some examples, the impedance profile may include impedance values in the range of about 85 to about 100 Ohms of differential impedance. In some examples, the impedance profile may include an impedance value of about 82 Ohms or 83 Ohms of differential impedance.

### Clause 2

The circuit board connector of clause 1, wherein the one or more dielectric structures comprise individual spacers with predetermined spacing therebetween, wherein the individual spacers comprise individual predetermined dimensions based in part on the intended impedance profile to be maintained across the barrel sections and the pins. In some examples, the predetermined dimensions may include a length of about 1.04 millimeters (mm) and a width of about 0.64 mm.

### Clause 3

The circuit board connector of clause 2, wherein the individual spacers comprise a first spacer located in a distal position with respect to a first end of the pair of leads, a second spacer located in a proximal position with respect to a second end of the pair of leads, and a third spacer located in a middle position with respect to the first end and the second end of the pair of leads.

### Clause 4

The circuit board connector of clause 2, wherein the individual spacers comprise one of different predetermined thicknesses as part of the dimension or shape, and wherein individual ones of the different predetermined thicknesses are associated with different impedance profiles available to be maintained across the barrel sections and the pins. In some examples, the predetermined thickness may be a value of about 0.30 mm.

### Clause 5

The circuit board connector of clause 1, wherein the one or more dielectric structures comprise an axial element with a plurality of distributed spacers, wherein the axial element extends substantially along a length which includes the barrel sections and the pins, and wherein the plurality of distributed spacers comprises a same predetermined spacing therebetween which is based in part on the intended impedance profile to be maintained across the barrel sections and the pins.

### Clause 6

The circuit board connector of clause 1, wherein the one or more dielectric structures comprise a plurality of axial elements with distributed spacers, wherein individual ones of the plurality of axial elements are at individual corners of the ground cage receptacle, and wherein the individual ones of the plurality of axial elements extend substantially along a length which includes the barrel sections and the pins.

### Clause 7

The circuit board connector of clause 6, wherein the individual ones of the plurality of axial elements extend laterally across a length of the ground cage receptacle.

### Clause 8

The circuit board connector of clause 1, wherein the circuit board connector is part of an array of circuit board connectors forming a lead frame connector between a first circuit board and a second circuit board or computing component, and wherein the dimension or shape is predetermined to allow or support a less than one percent deviation in a practical application of an impedance profile, with respect to the intended impedance profile.

### Clause 9

The circuit board connector of clause 1, wherein the one or more dielectric structures are resiliently movable or deformable when the circuit board connector is associated with a receiving connector of a circuit board. In some examples, the one or more dielectric structures are from a material such as Teflon® or comprising Teflon or other polytetrafluoroethylene (PTFE).

### Clause 10

The circuit board connector of clause 1, wherein the one or more dielectric structures comprise discontinuous edges along a boundary which is within the ground cage receptacle and comprises at least one air gap within the one or more dielectric structures and between the pair of leads.

### Clause 11

A system, comprising: a plurality of ground cage receptacles; and a plurality of lead sections comprising individual pairs of leads within individual ones of the plurality of ground cage receptacles, wherein a pair of leads comprises barrel sections and pins, the barrel sections being of different dimensions relative to the pins, wherein the individual ones of the plurality of ground cage receptacles are separated from respective barrel sections and respective pins by one or more dielectric structures, and wherein the one or more dielectric structures comprise one or more of a dimension or shape which is predetermined based at least in part on an intended impedance profile to be maintained across the barrel sections and the pins.

### Clause 12

A datacenter, comprising: a midplane or a backplane comprising a plurality of signal surface contact pads and a plurality of ground surface contact pads, channels, or lines; and one or more daughter boards coupled to the midplane or backplane through a lead frame connector, the lead frame connector comprising: a plurality of ground cage receptacles; and a plurality of lead sections comprising individual pairs of leads within individual ones of the plurality of ground cage receptacles, wherein a pair of leads comprises barrel sections and pins, the barrel sections being of different dimensions relative to the pins, wherein the individual ones of the plurality of ground cage receptacles are separated from respective barrel sections and respective pins by one or more dielectric structures, and wherein the one or more dielectric structures comprise one or more of a dimension or shape which is predetermined based at least in part on an intended impedance profile to be maintained across the barrel sections and the pins.

### Clause 13

A receiving connector comprising a receiving cage receptacle and provided on a circuit board, wherein the receiving connector is to receive an applied circuit board connector comprising a ground cage receptacle which is around a pair of leads, the pair of leads comprising barrel sections and pins, the barrel sections of different dimensions relative to the pins, wherein the ground cage receptacle is separated from the barrel sections and the pins by one or more dielectric structures, and wherein the one or more dielectric structures comprise one or more of a dimension or shape which is predetermined based at least in part on an intended impedance profile to be maintained across the barrel sections and the pins, and with respect to the receiving cage receptacle or a ground of the circuit board.

### Clause 14

A method for a circuit board connector, the method comprising: forming a ground cage receptacle which is around a pair of leads, the pair of leads comprising barrel sections and pins, the barrel sections of different dimensions relative to the pins; determining one or more dielectric structures comprising one or more of a dimension or shape which is predetermined based at least in part on an intended impedance profile to be maintained across the barrel sections and the pins; and allowing the ground cage receptacle to be separated from the barrel sections and the pins by the one or more dielectric structures.

### Clause 15

The method of clause 14, further comprising: determining individual spacers comprising individual predetermined dimensions based in part on the intended impedance profile to be maintained across the barrel sections and the pins; and allowing the one or more dielectric structures to comprise the individual spacers with predetermined spacing therebetween, wherein the predetermined spacing is also based in part on the intended impedance profile to be maintained across the barrel sections and the pins.

### Clause 16

The method of clause 15, further comprising one or more of: allowing the individual spacers to comprise a first spacer located in a distal position with respect to a first end of the pair of leads, a second spacer located in a proximal position with respect to a second end of the pair of leads, and a third spacer located in a middle position with respect to the first end and the second end of the pair of leads; or allowing the individual spacers to comprise one of different predetermined thicknesses as part of the dimension or shape, and wherein individual ones of the different predetermined thicknesses are associated with different impedance profiles available to be maintained across the barrel sections and the pins.

### Clause 17

The method of clause 14, further comprising: determining an axial element to extend substantially along a length which includes the barrel sections and the pins; allowing the one or more dielectric structures to comprise the axial element with a plurality of distributed spacers; and preparing the plurality of distributed spacers to comprise a same predetermined spacing therebetween which is based in part on the intended impedance profile to be maintained across the barrel sections and the pins.

### Clause 18

The method of clause 14, further comprising: determining a plurality of axial elements with distributed spacers for the circuit board connector; allowing individual ones of the plurality of axial elements to be at individual corners of the ground cage receptacle; and allowing the individual ones of the plurality of axial elements to extend substantially along a length which includes the barrel sections and the pins or allowing the individual ones of the plurality of axial elements to extend laterally across the length of the ground cage receptacle.

### Clause 19

The method of clause 14, further comprising one or more of: allowing the one or more dielectric structures to be resiliently moved or deformed when the connector is associated with a receiving connector of a circuit board; or allowing the one or more dielectric structures to comprise discontinuous edges along a boundary which is within the ground cage receptacle and to comprise at least one air gap within the one or more dielectric structures and between the pair of leads.

### Clause 20

The method of clause 14, further comprising: allowing the circuit board connector to be part of an array of connectors forming a lead frame connector between a first circuit board and a second circuit board or computing component; and predetermining the dimension or shape to allow or support a less than one percent deviation in a practical application of an impedance profile, with respect to the intended impedance profile.

### Clause 21

A circuit board connector comprising a ground cage receptacle which is around a pair of leads, the pair of leads comprising barrel sections and pins, the barrel sections of different dimensions relative to the pins, wherein the ground cage receptacle is separated from the barrel sections and the pins by one or more dielectric structures, and wherein the dielectric structures within the ground cage receptacle provide mechanical support and/or electrical tuning to the pair of leads and a ground reference.

### Clause 22

A circuit board connector comprising a ground cage receptacle which is around a pair of leads, the pair of leads comprising barrel sections and pins, the barrel sections of different dimensions relative to the pins, wherein the ground cage receptacle is separated from the barrel sections and the pins by one or more dielectric structures, and wherein the pins are spring-loaded to retract into the barrel sections upon contact with a receiving connector.

As such, in at least one example, the systems and methods disclosed herein may be also for a circuit board connector having a ground cage receptacle which is around a pair of leads. The pair of leads may include barrel sections and pins. The barrel sections may be of different dimensions relative to the pins. The ground cage receptacle may be separated from the barrel sections and the pins by one or more dielectric structures. The one or more dielectric structures may include one or more of a dimension or shape which is predetermined based at least in part on an intended impedance profile to be maintained across the barrel sections and the pins.

What is claimed is:

1. A connector comprising a ground cage receptacle, wherein the ground cage receptacle couples to a receiving cage receptacle of a circuit board to provide a ground reference for a data signal, wherein a plurality of compression signal pins interface with the circuit board to provide the data signal, and wherein the ground cage receptacle also separates the ground reference and the data signal.

2. The connector of claim 1, wherein the ground cage receptacle fits over the receiving cage receptacle and wherein a stop feature is part of an external insulation that is around the receiving cage receptacle or wherein the ground cage receptacle fits inside the receiving cage receptacle and wherein the stop feature is part of an internal insulation within the receiving cage receptacle.

3. The connector of claim 1, wherein a contact which is between the plurality of compression signal pins and signal surface contact pads of a receiving connector on the circuit board is a predetermined contact application comprising a predetermined pressure or contact resistance between the plurality of compression signal pins and the signal surface contact pads.

4. The connector of claim 1, wherein the plurality of compression signal pins is to extend from or retract into a barrel section which is within the connector, based in part at least one stop feature associated with the receiving cage receptacle, and wherein the stop feature holds the ground cage receptacle at a predetermined position with respect to the receiving cage receptacle and allows the plurality of compression signal pins to contact signal surface contact pads on the circuit board for transmission of the data signal to the circuit board.

5. The connector of claim 1, wherein the connector is one or more of:
part of a differential signal connection with a plurality of signal surface contact pads of a receiving connector, wherein the data signal of the plurality of compression signal pins is one of a set of differential signals to the plurality of signal surface contact pads and which is supported by the ground reference from the ground cage receptacle; or
located on a daughter board and wherein the receiving cage receptacle is associated with a receiving connector on a backplane or midplane, wherein the receiving cage receptacle is soldered or affixed to ground surface contact pads, channels, or lines on the backplane or midplane, and wherein the signal surface contact pads are within a perimeter formed by the ground surface contact pads, channels, or lines.

6. The connector of claim 1, wherein the connector is part of an array of connectors forming a lead frame connector between the circuit board and a further circuit board or computing component.

7. The connector of claim 1, further comprising:
a lead section and a barrel section, wherein the barrel section is coupled to or formed from part of the lead section, wherein the lead section allows transmission of the data signal within the connector, and wherein the ground cage receptacle is also around the lead section.

8. The connector of claim 1, further comprises:
rigid insulation which is around the ground cage receptacle to allow a rigid form factor for the connector.

9. The connector of claim 1, further comprises:
a first barrel section to couple, through a lead section, to a second barrel section, wherein the second barrel section is coupled to a daughter board and the first barrel section is to couple to a midplane or a backplane of a rack in a datacenter, and wherein the ground cage receptacle extends from the second barrel section to the first barrel section to provide the ground reference between the daughter board and the midplane or the backplane.

10. The connector of claim 1, further comprising:
parallel leads in a lead section, parallel barrels in a barrel section, and the ground cage receptacle over the parallel leads and the parallel barrels, wherein the parallel barrels comprise further compression signal pins, and wherein the further compression signal pins are to support or allow differential signals therebetween with the ground cage receptacle to support or allow the ground reference for the differential signals; and
an array of the parallel leads to allow the connector to be part of a lead frame connector.

11. The connector of claim 1, wherein the ground cage receptacle comprises a copper alloy, pin comprises one or more of a copper alloy or gold plating, wherein a barrel within the ground cage receptacle comprises one or more of a copper alloy or nickel plating, and wherein a spring within the barrel comprises stainless steel.

12. The connector of claim 1, further comprising a lead section wherein the lead section and the ground cage receptacle comprise an angled feature to allow a 90-degree angle of separation between one barrel section of the connector and another barrel section of another connector.

13. A system, comprising:
a plurality of ground cage receptacles; and
a plurality of barrel sections comprising pins and springs, wherein individual ones of the plurality of ground cage receptacles are around individual pairs of the plurality of barrel sections, wherein the plurality of ground cage receptacles couples to a plurality of receiving cage receptacles of a circuit board to provide ground references for data signals through the pins and the springs, wherein the pins are to extend from or retract into respective ones of the plurality of barrel sections based in part at least respective stop feature associated with respective ones of the plurality of receiving cage receptacles, and wherein the respective stop features are to hold the plurality of ground cage receptacles at a predetermined position with respect to the plurality of receiving cage receptacles and to allow the pins to contact signal surface contact pads on the circuit board for transmission of the data signals to the circuit board.

14. A datacenter, comprising:
a midplane or a backplane comprising a plurality of signal surface contact pads for differential signals, comprising a plurality of ground surface contact pads, channels, or lines, and comprising a plurality of receiving cage receptacles individually associated with the plurality of ground surface contact pads, channels, or lines; and
one or more daughter boards coupled to the midplane or backplane through a lead frame connector, the lead frame connector comprising:
a plurality of connectors arranged in an array; and
a plurality of ground cage receptacles within the plurality of connectors, the plurality of ground cage receptacles around a plurality of barrel sections comprising pins and springs, wherein individual ones of the plurality of ground cage receptacles are around individual pairs of the plurality of barrel sections, wherein the plurality of ground cage receptacle couples to the plurality of receiving cage receptacles to provide ground references for data signals through the pins and the springs, wherein the pins are to extend from or retract into respective ones of the plurality of barrel sections based at least in part on a respective stop feature associated with respective ones of the plurality of receiving cage receptacles, and wherein the respective stop features are to hold the plurality of ground cage receptacles at a predetermined position with respect to the plurality of receiving cage receptacles and to allow the pins to contact the signal surface contact pads for transmission of the data signals between the one or more daughter boards and the midplane or the backplane.

15. A receiving connector comprising a receiving cage receptacle and a stop feature associated with the receiving cage receptacle affixed to a circuit board, wherein the stop feature holds a ground cage receptacle of an applied connector at a predetermined position with respect to the receiving cage receptacle and allows a pin of the applied connector to contact a signal surface contact pad on the circuit board for transmission of a data signal to the circuit board, and wherein the receiving cage receptacle couples to an ground cage receptacle of the applied connector for provision of a ground reference between the receiving connector and the applied connector.

16. A method for a connector for signaling, the method comprising;
forming a lead section according to a layout for the connector;
forming a barrel section which is associated with the lead section;
associating a pin and a spring within the barrel section;
forming a ground cage receptacle which is around at least the barrel section of the connector, the ground cage receptacle to couple to a receiving cage receptacle and to provide a ground reference;
allowing the pin to extend from or retract into the barrel section based in part on an interface with the spring and with a stop feature associated with the receiving cage receptacle, the stop feature to hold the ground cage receptacle at a predetermined position with respect to the receiving cage receptacle; and
allowing the connector to be used for the signaling between at least two circuit boards or components of the circuit boards, wherein the pin is to contact a surface contact pad on at least one of the circuit boards to pass signals between the circuit boards and through the connector.

17. The method of claim 16, further comprising:
forming the ground cage receptacle to fit over the receiving cage receptacle; and
forming the stop feature as part of an external insulation or receiving connector that is around the receiving cage receptacle or as part of an internal insulation within the receiving cage receptacle and within the receiving connector.

18. The method of claim 16, further comprising:
determining a contact application comprising a predetermined pressure or contact resistance between the pin and a signal surface contact pad; and
allowing the contact between the pin and the signal surface contact pad based in part on the contact application.

19. The method of claim 16, further comprising:
allowing the connector to be part of a daughter board;
allowing the receiving cage receptacle to be part of a backplane or midplane; and
soldering or affixing the receiving cage receptacle to ground surface contact pads, channels, or lines on the backplane or midplane, and wherein there are signal surface contact pads within a perimeter formed by the ground surface contact pads, channels, or lines.

20. The method of claim 16, further comprising:
allowing, using the connector, a differential signal connection with the ground reference, wherein a data signal of the pin is one of a set of differential signals and wherein the pin is one of a set of differential signal pins supported by the ground reference from the ground cage receptacle.
